(19) United States
(12) Patent Application Publication
(10) Pub. No.: US 2026/0065018 A1
(43) Pub. Date: Mar. 5, 2026

(54) MULTI-DEVICE LARGE LANGUAGE MODEL DISTRIBUTION WITH INPUT CHUNKING

(71) Applicant: QUALCOMM Incorporated, San Diego, CA (US)

(72) Inventors: Qi XUE, San Diego, CA (US); Abhijit NAVALEKAR, Westford, MA (US)

(21) Appl. No.: 18/821,026

(22) Filed: Aug. 30, 2024

(51) Int. Cl. G06N 3/045; G06N 3/0475

(52) U.S. Cl. CPC G06N 3/045; G06N 3/0475

(57) ABSTRACT

Various embodiments include systems and methods for distributing a large generative AI model (LXM) across computing devices and implementing the LXM distributed across the computing devices. Embodiments may include dividing the LXM into portions, each portion having at least one input layer, decoder layer, or output layer, with the division based on characteristics of the computing devices. Some embodiments may include receiving a second set of characteristics of the computing devices, including at least one value different from values in the first set of characteristics, dividing the LXM into second portions that each has at least one layer of the LXM, wherein dividing the LXM is based on the second set of characteristics, and allocating the second portions to a second plurality of the computing devices.

### BACKGROUND

Recent advancements in artificial intelligence (AI) and machine learning (ML) technologies have led to the development of increasingly sophisticated models capable of understanding and interpreting complex data structures. These models, commonly known as large generative AI models (LXMs), have a multitude of applications that span across various domains, from natural language processing to computer vision and speech recognition. Their efficacy stems from their ability to learn from massive datasets, gaining an unprecedented depth of understanding and applicability.

The increasing capabilities of LXMs, including (but not limited to) Large Language Models (LLMs), Large Speech Models (LSMs), and Large Vision Models (LVMs) (which are also referred to as Language Vision Models or Vision Language Models (VLMs)), offer enhanced functionality in various applications such as natural language understanding, speech recognition, visual analysis, text generation, speech generation, image generation, and/or the like. Among the diverse types of LXMs, LLMs are generally known for their capabilities in understanding and generating human language. These models may be trained on extensive textual datasets and may perform such tasks as machine translation, text summarization, question-answering, and/or the like. LLMs have found applications in a broad range of industries including healthcare, finance, and customer service, among others.

An LSM is a type of LXM specializing in processing and understanding auditory data. LSMs may translate spoken language into textual form and vice versa. LSMs excel at tasks such as speech-to-text conversion, voice recognition, natural language understanding within a spoken context, providing spoken word responses in machine-generated voices, and/or the like. The efficacy of LSMs lies in their capacity to learn from enormous datasets containing diverse accents, dialects, and languages.

An LVM is a LXM that is trained to interpret and analyze visual data. LVM models may use convolutional neural networks or similar architectures to process visual inputs and derive meaningful conclusions from them. From image classification to object detection and generating new images in response to natural language prompts, LVMs are growing in popularity and use in diverse areas such as medical imaging, autonomous vehicles, surveillance systems, advertising, and entertainment.

### SUMMARY

Various aspects include systems and methods of distributing a large generative AI model (LXM) across a cluster of computing devices. Aspects may include dividing the LXM into first portions that each has at least one layer of the LXM in which the division is based on a first set of characteristics of the computing devices of the cluster, and allocating the first portions to a first plurality of the computing devices for execution.

Some aspects may further include receiving a second set of characteristics of the computing devices including at least one value different from values in the first set of characteristics, dividing the LXM into second portions that each has at least one layer of the LXM in which the division is based on the second set of characteristics, and allocating the second portions to a second plurality of the computing devices.

In some aspects, the second plurality of the computing devices may include at least one computing device of the first plurality of the computing devices.

In some aspects, the first set of characteristics of the computing devices includes available memory bandwidth, available compute capacity, and available communication bandwidth between the computing devices.

In some aspects, dividing the LXM into the first portions that each has the at least one layer of the LXM in which the division is based on the first set of characteristics of the computing devices of the cluster may include dividing the LXM into the first portions that each has the at least one layer of the LXM in which the division is based on the first set of characteristics of the computing devices of the cluster so as to approximately balance execution time of the first portions by the first plurality of the computing devices.

In some aspects, dividing the LXM into the first portions that each has the at least one layer of the LXM in which the division is based on the first set of characteristics of the computing devices of the cluster may include dividing the LXM into the first portions that each has the at least one layer of the LXM in which the division is based on the first set of characteristics of the computing devices of the cluster and a length of at least one input token.

In some aspects, the at least one layer of the LXM of any of the first portions may include one or more of one or more input layers, one or more decoder layers, or one or more output layers.

Further aspects include a computing device including at least one processing system including at least one memory having executable instructions thereon coupled to one or more processors configured to execute the executable instructions in order to perform operations of any of the methods summarized above. Further aspects include a non-transitory processor system-readable storage medium having stored thereon processor system-executable software instructions configured to cause a processor to perform operations of any of the methods summarized above. Further aspects include a computing device having means for accomplishing functions of any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a component block diagram illustrating example components in a system in package (SIP) that may be included in a computing device and configured to implement some embodiments.

FIG. 2 is a component diagram illustrating an example of a distributed AI computing system in accordance with some embodiments.

FIGS. 3A and 3B are component block diagrams illustrating examples of a distributed AI computing system in accordance with some embodiments.

FIG. 4 is a block diagram illustrating an example neural network architecture suitable for use in accordance with some embodiments.

FIGS. 5A-5F are block diagrams illustrating examples of large generative AI model (LXM) distribution across computing devices of a distributed AI computing system in accordance with some embodiments.

FIG. 6A is a block diagram Illustrating LXM input processing in an LXM distribution across computing devices of a distributed AI computing system in accordance with some embodiments.

FIG. 6B is a block diagram Illustrating LXM input chunking and chunk parallel processing in an LXM distribution across computing devices of a distributed AI computing system in accordance with some embodiments.

FIGS. 7A and 7B are process flow diagrams illustrating example methods of distributing an LXM across computing devices of a distributed AI computing system in accordance with some embodiments.

FIG. 8A and 8B are process flow diagrams illustrating an example method of implementing an LXM distributed across a cluster of computing devices in accordance with some embodiments.

FIGS. 9A-9C are process flow diagrams illustrating example methods implementing an LXM distributed across a cluster of computing devices in accordance with some embodiments.

FIG. 10 is a process flow diagram illustrating an example method of implementing an LXM distributed across a cluster of computing devices in accordance with some embodiments.

FIG. 11 is a component block diagram illustrating an example wireless communication device suitable for use with various embodiments.

FIG. 12 is a component block diagram illustrating an example computing device in the form of a laptop that is suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

In overview, various embodiments include methods, and computing devices and processing systems configured to implement the methods, of distributing a large generative AI model (LXM) across computing devices. Some embodiments may divide the LXM into portions, with each portion having at least one input layer, decoder layer, or output layer, and the division made based on characteristics of the computing devices, and allocate the portions to the computing devices. In some embodiments, the LXM may be divided into portions so that execution time of the portions as allocated to the computing devices are approximately balanced across the computing devices.

Various embodiments include methods, and computing devices and processing systems configured to implement the methods, of implementing the LXM distributed across the computing devices. Some embodiments may identify an input chunk size based on the characteristics of the computing devices and divide an input token into input chunks of the input chunk size. Some embodiments may process an input chunk by executing a portion of the LXM generating an intermediary chunk and transmit the intermediary chunk to a distributed computing device configured to process the intermediary chunk by executing another portion of the LXM. Some embodiments may process another input chunk by executing the portion generating other intermediary chunks for the other input chunk in parallel with transmitting the intermediary chunks for the prior input chunk.

The terms “computing device,” “user end device” and “end device” may be used herein to refer to (but not limited to) any one or all of personal computing devices, personal computers, workstations, laptop computers, Netbooks, Ultrabook, tablet computers, mobile communication devices, smartphones, user equipment (UE), personal data assistants (PDAs), palm-top computers, wireless electronic mail receivers, multimedia internet-enabled cellular telephones, media and entertainment systems, gaming systems (e.g., PlayStation™, Xbox™, Nintendo switch™), media players (e.g., DVD players, Roku™, apple TV™), digital video recorders (DVRs), portable projectors, 3D holographic displays, wearable devices (e.g., earbuds, smartwatches, fitness trackers, augmented reality (AR) glasses, head-mounted displays, etc.), vehicle systems such as drones, automobiles, motorcycles, connected vehicles, electric vehicles, automotive displays, advanced driver-assistance systems (ADAS), etc., cameras (e.g., surveillance cameras, embedded cameras), smart devices (e.g., smart light bulbs, smartwatches, thermostats, smart glasses, etc.), Internet of Things (IOT) devices, home routers, access points, other similar devices that include communication circuitry and a programmable processor that may be configured to provide the functionality of various embodiments.

The term “processing system” is used herein to refer to one more processors, including multi-core processors, that are coupled to at least one memory, organized and configured to perform various computing functions. Various embodiment methods may be implemented in one or more of multiple processors within a processing system as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), one or more memory blocks (e.g., ROM, RAM, Flash, etc.), and resources (e.g., timers, voltage regulators, oscillators, etc.). For example, an SoC may include an applications processor that operates as the SoC’s main processor, central processing unit (CPU), microprocessor unit (MPU), arithmetic logic unit (ALU), etc. An SoC processing system also may include software for controlling integrated resources and processors, as well as for controlling peripheral devices.

The term “system in a package” (SIP) is used herein to refer to a single module or package that contains multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The term “neural network” is used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” is used herein to refer to a process that is performed at runtime or during the execution of the software application program corresponding to the neural network. Inference may include traversing the processing nodes in the neural network along a forward path to produce one or more values as an overall activation or overall “inference result.”

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The output layer of nodes may be referred to as an output layer. The layers in-between the input and output layer may be referred to as intermediate layers, hidden layers, or black-box layers.

Each layer in a neural network may have multiple inputs and thus multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer and multiple preceding layers.

The term “recurrent neural network” (RNN) is used herein to refer to a class of neural networks particularly well-suited for sequence data processing. Unlike feedforward neural networks, RNNs may include cycles or loops within the network that allow information to persist. This enables RNNs to maintain a “memory” of previous inputs in the sequence, which may be beneficial for tasks in which temporal dynamics and the context in which data appears are relevant.

The term “long short-term memory network” (LSTM) is used herein to refer to a specific type of RNN that addresses some of the limitations of basic RNNs, particularly the vanishing gradient problem. LSTMs include a more complex recurrent unit that allows for the easier flow of gradients during backpropagation. This facilitates the model’s ability to learn from long sequences and remember over extended periods, making it apt for tasks such as language modeling, machine translation, and other sequence-to-sequence tasks.

The term “transformer” is used herein to refer to a specific type of neural network that includes an encoder and/or a decoder and is particularly well-suited for sequence data processing. Transformers may use multiple self-attention components to process input data in parallel rather than sequentially. The self-attention components may be configured to weigh different parts of an input sequence when producing an output sequence. Unlike solutions that focus on the relationship between elements in two different sequences, self-attention components may operate on a single input sequence. The self-attention components may compute a weighted sum of all positions in the input sequence for each position, which may allow the model to consider other parts of the sequence when encoding each element. This may offer advantages in tasks that benefit from understanding the contextual relationships between elements in a sequence, such as sentence completion, translation, and summarization. The weights may be learned during the training phase, allowing the model to focus on the most contextually relevant parts of the input for the task at hand. Transformers, with their specialized architecture for handling sequence data and their capacity for parallel computation, often serve as foundational elements in constructing large generative AI models (LXM).

The term “tensor” is used herein to refer to a vector or array (e.g., multi-dimensional array) that serves as the fundamental building block for various operations within a neural network. Tensors may store numerical values and may exist in multiple dimensions, permitting the encoding of various data types, such as scalars (0D tensors), vectors (1D tensors), matrices (2D tensors), or higher-dimensional arrays. For example, a 3D tensor may store red-green-blue (RGB) color values for a set of images. The dimensions of a tensor may be referred to as “axes,” and the number of axes may be called the “rank” of the tensor. Tensors are commonly used in machine learning and AI technologies for tasks including, but not limited to, data storage, transformation, and optimization. Tensor operations may include mathematical or computational manipulations of tensors, such as element-wise addition, multiplication, tensor contraction, transposition, and other linear transformations. Modern computing devices may include specialized hardware or software components configured to perform tensor operations and efficiently handle these high-dimensional arrays. These components may be included as part of a processing system and/or may include dedicated tensor processing units (TPUs), specialized instruction sets in a central processing unit (CPU), compute unified device architecture (CUDA) cores in a graphics processing unit (GPU), etc.

The term “decoder blocks” is used herein to refer to particular segments or sections within a neural network configured to interpret or translate encoded representations of data into a format more suitable for further processing or direct interpretation. Decoder blocks often work in conjunction with encoder blocks to carry out tasks such as sequence-to-sequence translation, summarization, or other types of transduction tasks. Decoder blocks may generate output sequences based on encoded input sequences and may transform one form of data representation into another. In models such as transformers, decoder blocks typically include layers, also referred to herein using the term “decoder layers,” that utilize features such as multi-headed self-attention, layer normalization, and feed-forward neural networks to convert compressed information back into a usable sequence or structure.

The phrase “tensor at the boundary of decoder blocks” is used herein to refer to specific tensors that exist or are computed at the transitional points between adjacent decoder blocks in a neural network. These tensors may include important information or intermediate representations that are used for the subsequent operations within the next decoder block. The boundary tensors may serve as input or output to particular layers within the decoder blocks and/or may form part of the overall inference operations.

The term “large generative AI model” (LXM) is used herein to refer to an advanced computational framework that includes any of a variety of specialized AI models including, but not limited to, large language models (LLMs), large speech models (LSMs), large/language vision models (LVMs), vision language models (VLMs)), hybrid models, and multi-modal models . An LXM may include multiple layers of neural networks (e.g., RNN, LSTM, transformer, etc.) with millions or billions of parameters. Unlike traditional systems that translate user prompts into a series of correlated files or web pages for navigation, LXMs support dialogic interactions and encapsulate expansive knowledge in an internal structure. As a result, rather than merely serving a list of relevant websites, LXMs are capable of providing direct answers and/or are otherwise adept at various tasks, such as text summarization, translation, complex question-answering, conversational agents, etc. In various embodiments, LXMs may operate independently as standalone units, may be integrated into more comprehensive systems and/or into other computational units (e.g., those found in a SoC or SIP, etc.), and/or may interface with specialized hardware accelerators to improve performance metrics such as latency and throughput. In some embodiments, the LXM component may be enhanced with or configured to perform an adaptive algorithm that allows the LXM to better understand context information and dynamic user behavior. In some embodiments, the adaptive algorithms may be performed by the same processing system that manages the core functionality of the LXM and/or may be distributed across multiple independent processing systems.

The terms “local LXM model” may be used to refer to a generative model that is stored on and/or executed by end device(s) and/or in a localized network. Local LXM models may reduce latency, improve efficiency, and help maintain user privacy by reducing or eliminating the need to send information from a user device to external servers for processing.

The term “embedding layer” is used herein to refer to a specialized layer within a neural network, typically at the input stage, that transforms discrete categorical values or tokens into continuous, high-dimensional vectors. An embedding layer may operate as a lookup table in which each unique token or category is mapped to a point in a continuous vector space. The vectors may be refined during the model’s training phase to encapsulate the characteristics or attributes of the tokens in a manner that is conducive to the tasks the model is configured to perform.

The term “token” is used herein to refer to a unit of information that an LXM may read as a single input during training and inference. Each token may represent any of a variety of different data types. For example, in text-centric models such as in LLMs, each token may represent a one or more textual element such as a paragraph(s), sentence(s), clause(s), word(s), sub-word(s), character(s), etc. In models designed for auditory data, such as LSMs, each token may represent a feature extracted from audio signals, such as a phoneme, spectrogram, temporal dependency, Mel-frequency cepstral coefficients (MFCCs) that represent small segments of an audio waveform, etc. In visual models such as LVM, each token may correspond to a portion of an image (e.g., pixel blocks), sequences of video frames, etc. In hybrid systems that combine multiple modalities (text, speech, vision, etc.), each token may be a complex data structure that encapsulates information from various sources. For example, a token may include both textual and visual information, each of which independently contributes to the token’s overall representation in the model. There are generally limitations on the total number of tokens that may be processed by AI models. As an example, a model with a limitation of 512 tokens may alter or truncate input sequences that go beyond this specific count.

Each token may be converted into a numerical vector by the embedding layer. Each vector component (e.g., numerical value, parameter, etc.) may encode an attribute, quality, or characteristic of the original token. The vector components may be adjustable parameters that are iteratively refined during the model training phase to improve the model’s performance during subsequent operational phases. The numerical vectors may be high-dimensional space vectors (e.g., containing more than 300 dimensions, etc.) in which each dimension in the vector captures a unique attribute, quality, or characteristic of the token. For example, dimension 1 of the numerical vector may encode the frequency of a word’s occurrence in a corpus of data, dimension 2 may represent the pitch or intensity of the sound of the word at its utterance, dimension 3 may represent the sentiment value of the word, etc. Such intricate representation in high-dimensional space may help the LXM understand the semantic and syntactic subtleties of its inputs. During the operational phase, the tokens may be processed sequentially through layers of the LXM or neural network, which may include structures or networks appropriate for sequence data processing, such as transformer architectures, recurrent neural networks (RNNs), or long short-term memory networks (LSTMs).

Some embodiments may be included in, work in conjunction with, communicate with, provide, and/or otherwise may be associated with a system of distributed AI computing devices. The distributed AI computing devices may be an ecosystem of interconnected components (e.g., computing devices, user devices, etc.) that are configured to extend intelligent, high-performance computing capabilities to end devices and local networks. The distributed AI computing devices may provide, support, or include a standardized and/or unified framework for data collection, task processing, and environment learning. The distributed AI computing devices may support hardware-agnostic platforms equipped with open protocols, application programming interfaces (APIs), and software, enabling the integration of a diverse gamut of devices and systems. The distributed AI computing devices may also support specialized or dedicated hardware arrangements and/or use proprietary protocols, APIs, and software for specialized applications.

Within the distributed AI computing devices framework, a processing system including one or more processors coupled to at least one memory may serve as the computational core of each of the interconnected components. The processing system may perform various operations to implement distributed AI computing devices or manage task execution, resource management, and other functionalities attributed to distributed AI computing devices. In some embodiments, the processing system may include an array of microprocessors, memory units, and I/O controllers that are communicatively linked.

A “cluster” may include a group of devices that are locally interconnected. In some embodiments, the devices of the cluster may operate under a singular administrative or user domain. Such devices may be connected through local networking technologies, such as Local Area Networks (LAN). A cluster may include both committed and opportunistic computing devices for specialized or general-purpose tasks. Committed devices are those primarily allocated for executing functionalities related to distributed AI computing devices, whereas opportunistic devices lend their excess computational resources when available.

Implementing an LXM on a computing device may require significant resources of the computing device to achieve required or expected level of performance. For example, an implementation of an LXM in a range of a 10 billion parameter (10B) model on a computing device may require approximately tens of gigabytes of memory, tens to hundreds of gigabytes per second of memory bandwidth, tens of trillions of operations per second (TOPS) of computing capability. For battery powered computing devices, the power cost may be far above typical power consumption for regular use.

Embodiments of distributing an LXM across multiple computing devices of a cluster may reduce the amount of resource consumption on a computing device by enabling the multiple computing devices to share the burden of implementing the LXM. Distributing an LXM across multiple computing devices may lower cost of individual computing devices for implementing the LXM while allowing for scaling for implementing larger LXMs distributed across more computing devices. The lower cost of individual computing devices may include reduced per device resource usage and power consumption.

In some embodiments, distributing an LXM across multiple computing devices may include distributing the LXM across an initial distributed AI computing device and one or more distributed AI computing devices. Distribution of the LXM may include determination of how to divide input layers, decoder layers, or output layers of the LXM and allocate the input layers, decoder layers, or output layers to the computing devices. Determinations of how to distribute the LXM may be based on characteristics of the LXM and/or the computing devices. Characteristics of the LXM may include varying sizes, complexities, parameters, and/or tokens. For example, the Characteristics of the LXM may include a number of decoder layers, a model dimension size, a number of parameters, a vocabulary size, a max context length, an attention mechanism (e.g., multi-head attention or group query attention), etc. Characteristics of the computing devices may include computing device capability and connectivity conditions between computing devices. For example, computing device capability may include available compute capacity, available memory capacity, available memory bandwidth, available power, etc. of each of the computing devices. As another example, connectivity conditions may include available bandwidth, signal strength, signal quality, signal reliability, signal latency, etc. between the computing devices. Determinations of how to distribute the LXM may be based on approximately balancing execution time the LXM, or the decoder layers, across the computing devices.

Computing device capability and connectivity conditions between computing devices may vary over time. In some embodiments, the LXM may be dynamically redistributed across multiple computing devices. Redistribution of the LXM across the computing devices may be implemented in a manner similar to a prior distribution of the LXM. In some embodiments, the LXM may be redistributed across the same computing devices as the prior distribution. In some embodiments, the LXM may be redistributed across different computing devices as compared to a prior distribution. Redistribution of the LXM across different computing devices may be across the initial distributed AI computing device and one or more distributed AI computing devices, where at least one distributed AI computing device is different from the one or more distributed AI computing devices of the prior distribution.

Embodiments implementing distribution of an LXM across multiple computing devices may also enable parallelization of data and compute operations for implementing the LXM across the computing devices. Parallelization of operations across the computing devices may be further aided by chunking of inputs to the LXM into input chunks sized based on various parameters. The input chunks may be batch processed by the initial distributed AI computing device serially executing one or more input layers and one or more decoder layers of the LXM generating intermediary chunks. The intermediary chunks may be processed by the one or more distributed AI computing devices executing one or more decoder layers.

One or more input chunks may be processed in parallel with transmission of one or more intermediary chunks between computing devices, such as between the initial distributed AI computing devices and a distributed AI computing device or between distributed AI competing devices. The one or more input chunks may also be processed in parallel with processing of the one or more intermediary chunks by one or more distributed AI computing devices. Similarly, the one or more intermediary chunks may be processed in parallel with transmission of one or more other intermediary chunks between distributed AI computing devices. The one or more intermediary chunks may also be processed in parallel with processing of the one or more other intermediary chunks by one or more other distributed AI computing devices.

Parallel processing of chunked inputs by multiple computing devices implementing the distributed LXM may improve end to end LXM performance in terms of token latency in comparison to serial processing of whole inputs within a single device. Such embodiments may also reduce a total cost of ownership (TOC) of individual computing devices of for implementing an LXM by reducing reliance on dedicated central AI hardware of a single computing device by opportunistically leveraging available distributed hardware of distributed AI computing devices.

An initial distributed AI computing device may orchestrate resource management within and in between clusters. The initial distributed AI computing device may dynamically distribute resources and tasks among devices based on parameters such as device capabilities, existing device workloads, task priority, task urgency, task complexity, etc. The initial distributed AI computing device may allow the dynamic addition or removal of devices or clusters in response to changing resource availability and/or changing computational demands. The initial distributed AI computing device may also consider the communication topology and conditions when making decisions about where to distribute workloads.

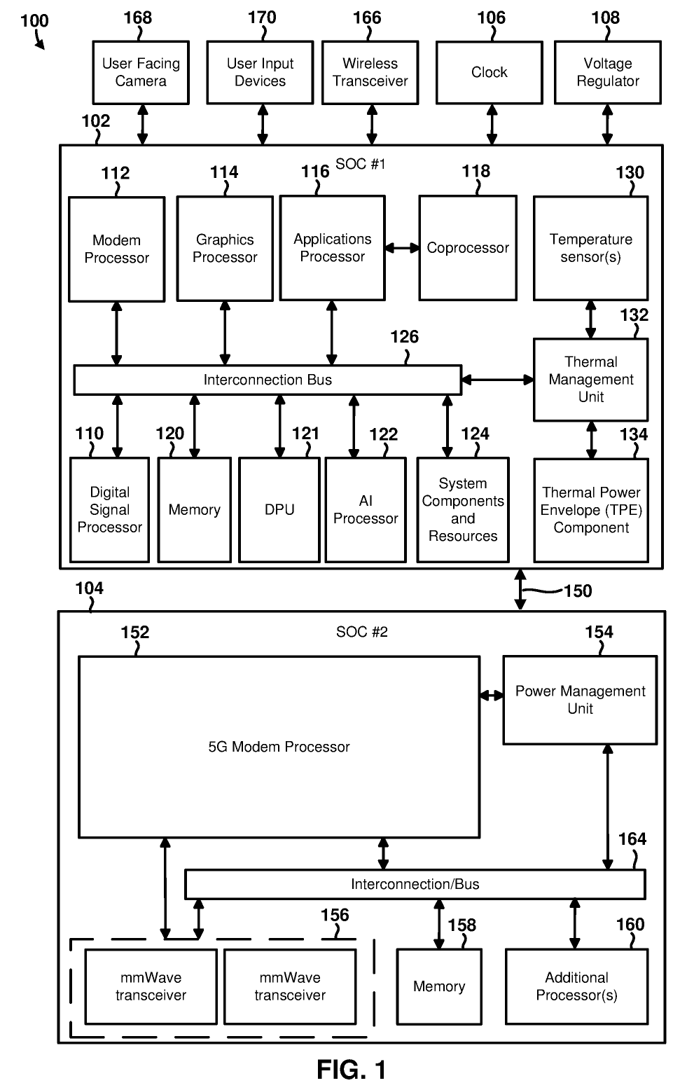

Various embodiments may be implemented on a number of single-processor and multiprocessor computer systems, including a system-on-chip (SOC) or system in a package (SIP). FIG. 1 illustrates an example computing system or SIP 100 architecture that may be used in mobile computing devices implementing a continuous speech-monitoring artificial intelligence (AI) system in accordance with various embodiments.

With reference to FIG. 1, the illustrated example SIP 100 includes two SOCs 102, 104, a clock 106, a voltage regulator 108, a wireless transceiver 166, a user facing camera 168 and user input devices 170 (e.g., a touch-sensitive display, a touch pad, a mouse, etc.). The first and second SOC 102, 104 may communicate via an interconnection bus 150. Various processors 110, 112, 114, 116, 118, 121, 122 may be interconnected to each other and to one or more memory elements 120, system components and resources 124, and a thermal management unit 132 via an interconnection bus 126, which may include advanced interconnects such as high-performance networks-on-chip (NOCs). Similarly, the processor 152 may be interconnected to the power management unit 154, the mmWave transceivers 156, at least one memory 158, and various additional processors 160 via the interconnection bus 164. These interconnection buses 126, 150, 164 may include an array of reconfigurable logic gates and/or implement a bus architecture (e.g., CoreConnect, AMBA, etc.). Communications may be provided by advanced interconnects, such as NOCs.

In various embodiments, any or all of the processors 110, 112, 114, 116, 121, 122, in the system may operate as the SoC’s main processor, central processing unit (CPU), microprocessor unit (MPU), arithmetic logic unit (ALU), etc. One or more of the coprocessors 118 may operate as the CPU.

In some embodiments, the first SOC 102 may operate as the central processing unit (CPU) of the mobile computing device that carries out the instructions of software application programs by performing the arithmetic, logical, control and input/output (I/O) operations specified by the instructions. In some embodiments, the second SOC 104 may operate as a specialized processing unit. For example, the second SOC 104 may operate as a specialized 5G processing unit responsible for managing high volume, high speed (e.g., 5 Gbps, etc.), and/or very high-frequency short wavelength (e.g., 28 GHz mmWave spectrum, etc.) communications.

The first SOC 102 may include a digital signal processor (DSP) 110, a modem processor 112, a graphics processor 114, an application processor 116, one or more coprocessors 118 (e.g., vector co-processor, tensor processing unit, CPUCP, etc.) connected to one or more of the processors, at least one memory 120, data processing unit (DPU) 121, artificial intelligence processor 122, system components and resources 124, an interconnection bus 126, one or more temperature sensors 130, a thermal management unit 132, and a thermal power envelope (TPE) component 134. The second SOC 104 may include a 5G modem processor 152, a power management unit 154, an interconnection bus 164, a plurality of mmWave transceivers 156, memory 158, and various additional processors 160, such as an applications processor, packet processor, etc.

Each processor 110, 112, 114, 116, 118, 121, 122, 121, 122, 152, 160 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 11). As another example, the graphics processor may include one or more compute unified device architecture (CUDA) cores configured to perform tensor operations. In addition, any or all of the processors 110, 112, 114, 116, 118, 121, 122, 121, 122, 152, 160 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122, 121, 122, 152, 160 may operate as the CPU of the mobile computing device. In addition, any or all of the processors 110, 112, 114, 116, 118, 121, 122, 121, 122, 152, 160 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node’s computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The first and second SOC 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, Access ports, timers, and other similar components used to support the processors and software clients running on a computing device. The system components and resources 124 may also include circuitry to interface with peripheral devices, such as cameras, electronic displays, wireless communication devices, external memory chips, etc.

The first and/or second SOCs 102, 104 may further include an input/output module (not illustrated) for communicating with resources external to the SOC, such as the clock 106, the voltage regulator 108, the wireless transceiver 166 (e.g., cellular wireless transceiver, Bluetooth transceiver, etc.), the user facing camera 168 and user input devices 170 (e.g., a touch-sensitive display, a touch pad, a mouse, etc.). Resources external to the SOC (e.g., clock 106, voltage regulator 108, wireless transceiver 166) may be shared by two or more of the internal SOC processors/cores.

In addition to the example SIP 100 discussed above, various embodiments may be implemented in various computing systems, including a single processor, multiple processors, multicore processors, or any combination thereof.

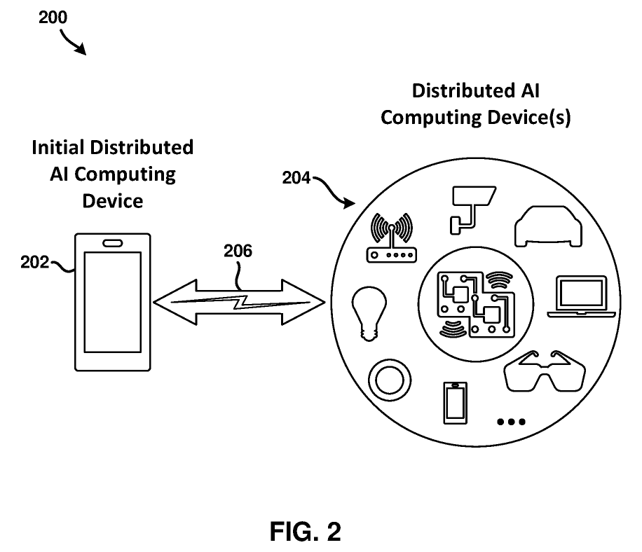

FIG. 2 is a component diagram illustrating an example of a distributed AI computing system 200 in accordance with some embodiments. With reference to FIGS. 1 and 2, the distributed AI computing system 200 may be a cluster of computing devices and include an initial distributed AI computing device 202 and one or more distributed AI computing devices 204. The initial distributed AI computing device 202 may include any computing device having at least a user interface, a processor system (e.g., SIP 100, SoC 102, 104, processor 110, 112, 114, 116, 118, 121, 122, 121, 122, 152, 160 in FIG. 1) and a wireless transceiver (e.g., mmWave transceivers 156, wireless transceiver 166 in FIG. 1). A distributed AI computing device 204 may be any computing device having at least a processor (e.g., SIP 100, SoC 102, 104, processor 110, 112, 114, 116, 118, 121, 122, 121, 122, 152, 160 in FIG. 1) and a wireless transceiver (e.g., mmWave transceivers 156, wireless transceiver 166 in FIG. 1).

The initial distributed AI computing device 202 and one or more distributed AI computing devices 204 may be communicatively linked via their wireless transceivers over one or more wireless communications networks 206. The wireless communication networks 206 may include a personal area network (PAN), a local area network (LAN), a wide local area network (WLAN), a wide area network (WAN), etc. The initial distributed AI computing device 202 and the one or more distributed AI computing devices 204 may communicate via one or more communication protocols. The communication protocols may include wireless communication protocols, mobile/cellular communication protocols, internet protocols, Internet of Things (IoT) communication protocols, etc. The initial distributed AI computing device 202 may be communicatively linked with and communicate with any two or more distributed AI computing devices 204 via the same or different wireless communications networks 206 and communication protocols.

In some embodiments, two or more distributed AI computing devices 204 may be communicatively linked via their wireless transceivers over one or more wireless communications networks 206. The wireless communications networks 206 may include a PAN, a LAN, a WLAN, a WAN, etc. The two or more distributed AI computing devices 204 may communicative via one or more communication protocols. The communication protocols may include wireless communication protocols, mobile/cellular communication protocols, internet protocols, IoT communication protocols, etc. Any distributed AI computing device 204 may be communicatively linked with and communicate with the initial distributed AI computing device 202 and any one or more distributed AI computing devices 204 via the same or different wireless communications networks 206 and communication protocols.

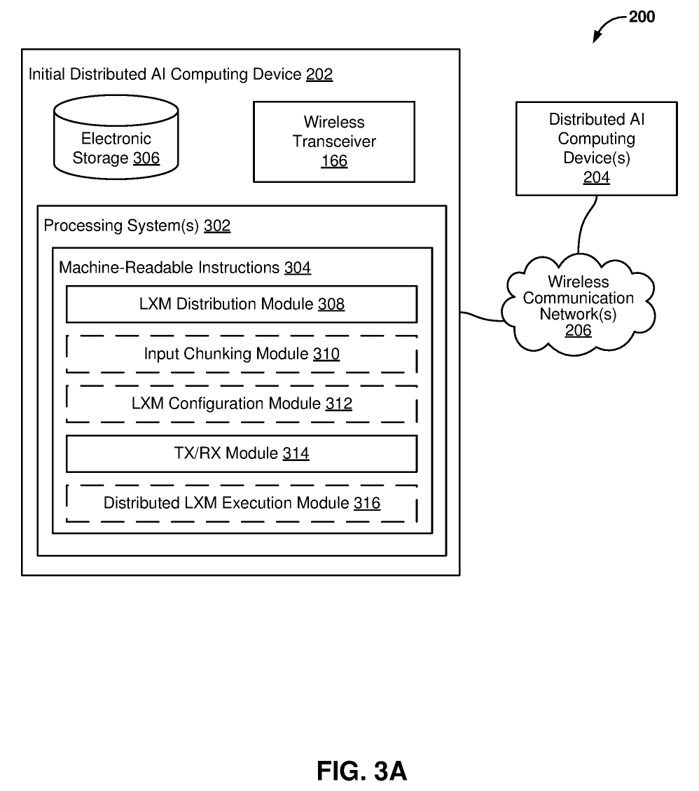

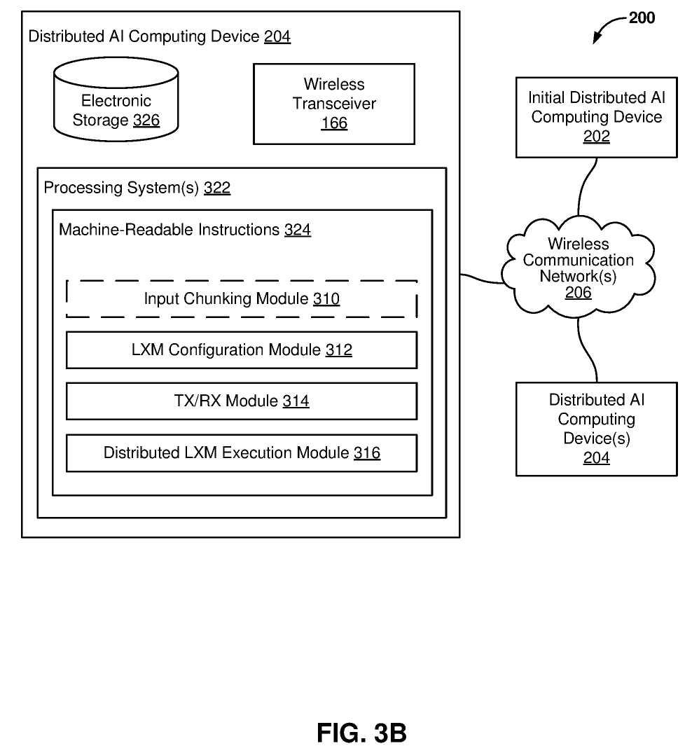

FIGS. 3A and 3B are component block diagrams illustrating an example of the distributed AI computing system 200 in accordance with some embodiments. With reference to FIGS. 1-3B, distributed AI computing system 200 may include the initial distributed AI computing devices 202 and the one or more distributed AI computing devices 204. The computing devices 202, 204 may each include one or more processing systems 302, 322 (e.g., SIP 100, SoC 102, 104, processor 110, 112, 114, 116, 118, 121, 122, 121, 122, 152, 160 in FIG. 1) coupled to electronic storage 306, 326 (e.g., memory 120, 158 in FIG. 1) and a wireless transceiver 166.

Referring to the initial distributed AI computing device 202, the processing system(s) 302 may be configured by machine-readable instructions 304. Machine-readable instructions 304 may include one or more instruction modules 308-316. The instruction modules 308-316 may include computer program modules. In some embodiments, the functions of the instruction modules 308-316 may be implemented in software, firmware, hardware (e.g., circuitry), or a combination of software and hardware, which are configured to perform particular operations or functions. The instruction modules 308-316 may include one or more of an LXM distribution module 308, optionally an input chunking module 310, optionally an LXM configuration module 312, a transmit/receive (TX/RX) module 314, optionally a distributed LXM execution module 316, or other instruction modules.

The LXM distribution module 308 may be configured to distribute the LXM across multiple computing devices, including any combination of the computing devices 202, 204. Based on characteristics of the computing devices 202, 204 and/or of the LXM and/or a token length, the LXM distribution module 308 may divide the LXM into multiple portions and allocate the portions to the computing devices 202, 204. Each portion of the LXM may include at least one input layer, decoder layer, or output layer of the LXM. Characteristics of the computing devices 202, 204 may include computing device capability and connectivity conditions between computing devices 202, 204. For example, computing device capability may include available compute capacity, available memory capacity, available memory bandwidth, available power, etc. of each of the computing devices 202, 204. As another example, connectivity conditions may include available bandwidth, signal strength, signal quality, signal reliability, signal latency, etc. between the computing devices 202, 204. Characteristics of the LXM may include varying sizes, complexities, parameters, and/or tokens. For example, the characteristics of the LXM may include a number of input layers, decoder layers, or output layers, a model dimension size, a number of parameters, a vocabulary size, a max context length, an attention mechanism (e.g., multi-head attention or group query attention), etc.

In some embodiments, the LXM distribution module 308 may identify, such as by estimation or calculation, a time for implementing one or more input layers, decoder layers, or output layers for each computing device 202, 204. The time for implementing one or more input layers, decoder layers, or output layers for any of the computing devices 202, 204 may be based on the characteristics of the computing device 202, 204 and/or of the LXM. For example, the time for implementing one or more input layers, decoder layers, or output layers which may be referred to as a token latency, may be a combination of a memory I/O latency, a compute latency, and a transmission latency. The memory I/O latency may be for loading weights & key values of the one or more input layers, decoder layers, or output layers and may be identified, for example, based on an available memory bandwidth of the computing device 202, 204. The compute latency may be for generating tokens over the one or more input layers, decoder layers, or output layers and may be identified, for example, based on an available compute capacity of the computing device 202, 204. The transmission latency for transmitting tokens between computing devices 202, 204 and may be identified, for example, based on connectivity conditions between computing devices 202, 204.

Using the time for executing one or more input layers, decoder layers, or output layers for each computing device 202, 204, the LXM distribution module 308 may identify how many input layers, decoder layers, or output layers each computing device 202, 204 may implement while balancing execution time the LXM, or the input layers, decoder layers, or output layers, across the computing device 202, 204. Similarly, the LXM distribution module 308 may identify which input layers, decoder layers, or input layers each computing device 202, 204 may be allocated to implement while balancing execution time of the LXM, or the input layers, decoder layers, or output layers, across the computing device 202, 204. In some embodiments, balancing execution time of the LXM, or the input layers, decoder layers, or output layers, across the computing device 202, 204 may include each of the computing devices 202, 204 taking approximately the same amount of time implementing allocated input layers, decoder layers, or output layers.

The input layers, decoder layers, and/or output layers to be allocated to a computing device 202, 204 may be collectively referred to as a portion of the LXM. The LXM distribution module 308 may generate information configured to indicate to computing devices 202, 204 the portions of the LXM allocated to the computing devices 202, 204.

In some embodiments, the LXM distribution module 308 may be continuously, periodically, or episodically implemented. The LXM distribution module 308 may be executed during implementation of an LXM across the computing devices 202, 204. The LXM distribution module 308 may dynamically redistribute the LXM across the computing devices 202, 204 during the implementation of the LXM.

A total time for implementing the decoder phase of the LXM across the computing devices 202, 204, which may also be referred to as a token latency, may be based on a combination of the time for each computing device 202, 204 to implement the allocated portions. The token latency may be calculated, for example, based on memory I/O latency, compute latency, and transmission latency of the computing devices 202, 204.

The input chunking module 310 may be optionally included on or executed by the initial distributed AI computing device 202. For example, the input chunking module 310 may be included on or executed by the initial distributed AI computing device 202 for embodiments in which the initial distributed AI computing device 202 may implement an input layer or a portion of the LXM. For another example, the input chunking module 310 may be included on or executed by the initial distributed AI computing device 202 for embodiments in which the distributed AI computing devices 204 do not implement a chunking module 310.

The input chunking module 310 may be configured to identify an input chunk size and divide input tokens to the LXM into input chunks of the input chunk size. The input chunk size may be identified based on various parameters. Some parameters may include the characteristics of the computing devices 202, 204 and/or of the LXM and/or a number of the computing devices 202, 204. Characteristics of the computing devices 202, 204 may include computing device capability and connectivity conditions between computing devices 202, 204. For example, computing device capability may include available compute capacity, available memory capacity, available memory bandwidth, available power, operating mode of the processing systems 302, 322 (e.g., CPU mode, neural processing unit (NPU) mode, etc.), etc. of each of the computing devices 202, 204. As another example, connectivity conditions may include available bandwidth, signal strength, signal quality, signal reliability, signal latency, etc. between the computing devices 202, 204. Characteristics of the LXM may include varying sizes, complexities, parameters, and/or token, such as token length during a prefill phase and a decode phase. For example, the characteristics of the LXM may include a number of input layers, decoder layers, or output layers, a model dimension size, a number of parameters, a vocabulary size, a max context length, an attention mechanism (e.g., multi-head attention or group query attention), etc.

In some embodiments, the input chunking module 310 may identify, such as by estimation or calculation, a metric for implementing the distributed LXM across the computing device 202, 204. The input chunk size may be identified to achieve various metrics. For example, input chunk size may be identified to achieve reduced token latency. Reduced token latency may be reduced relative to implementation of the LXM on a single computing device 202, 204 or multiple computing devices 202, 204 using an undivided, or whole, input to the LXM. The token latency may be calculated, for example, based on memory I/O latency, compute latency, and transmission latency of the computing devices 202, 204 for one or more input chunk sizes.

Based on the identification of an input chunk size, the input chunking module 310 may divide an input to the LXM into input chunks of the input chunk size. In some embodiments, the input chunk size may be static or dynamic, based on different scenarios and requirements like multi-user support.

In some embodiments, the input chunking module 310 may be continuously, periodically, or episodically implemented. The input chunking module 310 may be executed during implementation of an LXM across the computing devices 202, 204. The input chunking module 310 may dynamically reidentify an input chunk size and divide a remaining part of the input token during the implementation of the LXM.

The distributed LXM configuration module 312 may be optionally included on or executed by the initial distributed AI computing device 202. For example, the distributed LXM configuration module 312 may be included on or executed by the initial distributed AI computing device 202 for embodiments in which the initial distributed AI computing device 202 may implement a portion of the LXM. The distributed LXM configuration module 312 may configure the initial distributed AI computing device 202 to implement the distributed LXM. The distributed LXM configuration module 312 may configure the processor system 302 and/or the distributed LXM execution module 316 to implement the portion of the LXM allocated to the initial distributed AI computing device 202 and not other portions of the distributed LXM. For example, the distributed LXM configuration module 312 may provide an indication of to the portion of the LXM allocated to the initial distributed AI computing device 202 to the processor system 302 and/or the distributed LXM execution module 316 directly, via a stored value, such as at the electronic storage 306, a register, etc.

The distributed LXM execution module 316 may be optionally included on or executed by the initial distributed AI computing device 202. For example, the distributed LXM execution module 316 may be included on or executed by the initial distributed AI computing device 202 for embodiments in which the initial distributed AI computing device 202 may implement at least part of the LXM. The distributed LXM execution module 316 may be configured to implement the distributed LXM on the initial distributed AI computing device 202. Based on a configuration of the distributed LXM execution module 316, implementing the distributed LXM on the initial distributed AI computing device 202 may include implementing one or more input layers, one or more decoder layers, and/or one or more output layers of the distributed LXM. For example, the distributed LXM execution module 316 may be configured to implement one or more input layers, such as during a prefill phase. As another example, the distributed LXM execution module 316 may be configured to implement one or more input layers and/or one or more output layers. As another example, the distributed LXM execution module 316 may be configured to dynamically change layer mapping between computing devices 202, 204. Based on the indication of the portion of the distributed LXM allocated to the initial distributed AI computing device 202 provided by the distributed LXM configuration module 312, the distributed LXM execution module 316 may implement the allocated portion, including one or more input layers, one or more decoder layers, and/or one or more output layers.

The distributed LXM execution module 316 may may batch process each input chunk of an input token of the input chunk size provided from the input chunking module 310. The distributed LXM execution module 316 may serially implement the layers of the LXM that the distributed LXM execution module 316 is configured to implement. For example, the distributed LXM execution module 316 may implement the one or more input layers and/or the one or more decoder layers for a first input chunk to generate a first intermediary chunk. In parallel with the TX/RX module 314 transmitting the first intermediary chunk to a distributed AI computing device 204, the distributed LXM execution module 316 may implement the one or more input layers and/or the one or more decoder layers for a second input chunk to generate a second intermediary chunk. The distributed LXM execution module 316 may also implement the one or more input layers and/or the one or more decoder layers for the second input chunk in parallel with one or more distributed AI computing devices 204 implementing the distributed LXM for the first intermediary chunk. The distributed LXM execution module 316 may continue to process subsequent input chunks of input tokens in parallel with the transmission of previous intermediary chunks by the TX/RX module 314.

In some embodiments, the distributed LXM execution module 316 may also implement one or more output layers to generate an output chunk. For example, the distributed LXM execution module 316 may implement the one or more output layers for a first input chunk to generate a third intermediary chunk received from a distributed AI computing device 204 via the TX/RX module 314. In parallel with the TX/RX module 314 receiving a subsequent fourth intermediary chunk, the distributed LXM execution module 316 may implement the one or more output layers for the third intermediary chunk to generate an output chunk. The distributed LXM execution module 316 may continue to process subsequent intermediary chunks in parallel with receiving of later intermediary chunks by the TX/RX module 314. In some embodiments, the distributed LXM execution module 316 may assemble the output chunks derived from the input chunks of an input token into an output probability or output tensor.

The TX/RX module 314 may be configured to receive the characteristics of one or more distributed AI computing devices 204 and provide the characteristics to the LXM distribution module 308 and the input chunking module 310. The TX/RX module 314 may also be configured to transmit which portions of the LXM are identified and allocated to the one or more distributed AI computing devices 204 by the LXM distribution module 308 to the one or more distributed AI computing devices 204. In some embodiments, the TX/RX module 314 may also be configured to transmit input chunks of input tokens generated by the input chunking module 310 or intermediary chunks generated by the distributed LXM execution module 316 to the one or more distributed AI computing devices 204. In some embodiments, the TX/RX module 314 may be configured to receive a prompt configured to trigger implementation of the distributed LXM and provide the prompt and/or input to the distributed LXM execution module 316. In some embodiments, the TX/RX module 314 may be configured to receive the input token from the client application and provide the input to the input chunking module 310. In some embodiments, the client application may be implemented on any of the computing devices 202, 204 or another computing device (not shown) connected to the initial distributed AI computing device 202 via the one or more wireless communication networks 206. In some embodiments, the TX/RX module 314 may be configured to receive output chunks, or output tensors, from one or more one or more distributed AI computing devices 204. In some embodiments, the TX/RX module 314 may be configured to provide the output chunks, or output tensors, to the client application.

Referring to the one or more distributed AI computing devices 204, the processing system(s) 322 may be configured by machine-readable instructions 324. Machine-readable instructions 324 may include one or more instruction modules 310-316. The instruction modules 310-316 may include computer program modules. In some embodiments, the functions of the instruction modules 310-316 may be implemented in software, firmware, hardware (e.g., circuitry), or a combination of software and hardware, which are configured to perform particular operations or functions. The instruction modules 310-316 may include one or more of optionally the input chunking module 310, the LXM configuration module 312, the TX/RX module 314, the distributed LXM execution module 316, or other instruction modules.

The input chunking module 310 may be optionally included on or executed by the distributed AI computing device 204. For example, the input chunking module 310 may be included on or executed by the distributed AI computing device 204 for embodiments in which the initial distributed AI computing device 202 or other distributed AI computing devices 204 do not implement an input chunking module 310. The input chunking module 310 may be implemented by the processing system 322 in a similar manner as described herein for the processing system 302 of the initial distributed AI computing device 202. In some embodiments, the TX/RX module 314 may be configured to receive an input token from a client application and provide the input to the input chunking module 310. In some embodiments, the client application may be implemented on any of the computing devices 202, 204 or another computing device (not shown) connected to the distributed AI computing device 204 via the one or more wireless communication networks 206.

The TX/RX module 314 may be configured to transmit the characteristics of the one or more distributed AI computing devices 204 to the initial distributed AI computing device 202. The TX/RX module 314 may also be configured to receive which portions of the LXM are allocated to the one or more distributed AI computing devices 204 from the initial distributed AI computing device 202 and provide which portions of the LXM are allocated to the one or more distributed AI computing devices 204 to the LXM configuration module 312.

The distributed LXM configuration module 312 may configure the one or more distributed AI computing devices 204 to implement the distributed LXM. The distributed LXM configuration module 312 may configure the processor system 322 and/or the distributed LXM execution module 316 to implement the portion of the LXM allocated to the one or more distributed AI computing devices 204 and not other portions of the distributed LXM. For example, the distributed LXM configuration module 312 may provide an indication of the portion of the LXM allocated to the one or more distributed AI computing devices 204 to the processor system 322 and/or the distributed LXM execution module 316 directly, via a stored value, such as at the electronic storage 326, a register, etc.

The TX/RX module 314 may also be configured to receive intermediary chunks from the one or more of the computing devices 202, 204 and provide the intermediary chunks to the distributed LXM execution module 316.

The distributed LXM execution module 316 may be configured to implement the distributed LXM on the one or more distributed AI computing devices 204. Based on a configuration of the distributed LXM execution module 316, implementing the distributed LXM on the one or more distributed AI computing devices 204 may include implementing one or more input layers, one or more decoder layers, and/or one or more output layers of the distributed LXM. Based on the indication of the portion of the distributed LXM allocated to the one or more distributed AI computing devices 204 provided by the distributed LXM configuration module 312, the distributed LXM execution module 316 may implement the allocated portion, including one or more input layers, decoder layers, or output layers. In some embodiments, the distributed LXM execution module 316 may implement the one or more input layers in a similar manner as described herein for the processing system 302 of the initial distributed AI computing device 202.

The distributed LXM execution module 316 may serially receive intermediary chunks from one or more computing devices 202, 204 and serially implement the layers of the LXM that the distributed LXM execution module 316 is configured to implement. For example, the one or more computing devices 202, 204 may implement the distributed LXM for a first input chunk or a first intermediary chunk and may generate a second intermediary chunk. The distributed LXM execution module 316 may implement the one or more decoder layers for the second intermediary chunk to generate a third intermediary chunk. The distributed LXM execution module 316 may be implemented for the second intermediary chunk in parallel with distributed LXM implementation of the one or more computing devices 202, 204 for a second input chunk or a fourth intermediary chunk. Further, in parallel with the TX/RX module 314 transmitting the third intermediary chunk to one or more computing devices 202, 204, the distributed LXM execution module 316 may implement the one or more decoder layers for the fourth intermediary chunk to generate a fifth intermediary chunk. The distributed LXM execution module 316 may also implement the one or more decoder layers for the fourth intermediary chunk in parallel with one or more distributed AI computing device 204 implementing the distributed LXM for the third intermediary chunk.

As another example, the one or more computing devices 202, 204 may implement the distributed LXM for a first input chunk or a first intermediary chunk and may generate a second intermediary chunk. The distributed LXM execution module 316 may implement the one or more decoder layers and out or more output layers for the second intermediary chunk to generate a first output chunk. The distributed LXM execution module 316 may be implemented for the second intermediary chunk in parallel with distributed LXM implementation of the one or more computing devices 202, 204 for a second input chunk or a third intermediary chunk. Further, in parallel with the TX/RX module 314 transmitting the first output chunk to the initial distributed AI computing device 204, the distributed LXM execution module 316 may implement the one or more decoder layers and the one or more output layers for the third intermediary chunk to generate a second output chunk. In some embodiments, the distributed LXM execution module 316 may assemble the output chunks derived from the input chunks of an input token into an output probability or output tensor.

The distributed LXM execution module 316 may continue to process subsequent intermediary chunks in parallel with the transmission of previous intermediary chunks or output chunks by the TX/RX module 314.

In some embodiments, the TX/RX module 314 may also be configured to transmit intermediary chunks generated by the distributed LXM execution module 316 to one or more distributed AI computing devices 204 and/or to the initial distributed AI computing device 202. In some embodiments the TX/RX module 314 may also be configured to transmit output chunks or output tensors generated by the distributed LXM execution module 316 to the initial distributed AI computing device 202. In some embodiments, the TX/RX module 314 may be configured to provide the output chunks, or output tensors, to the client application.

The wireless transceiver 166 may be configured to transmit and receive radio signals transmitted between the computing devices 202, 204 via the one or more wireless communication networks 206. The wireless transceiver 166 may convert digital signals provided from the processing system(s) 302, 322 to radio signals for transmission and convert radio signals received from the one or more wireless communications network(s) to digital signals for the processing system(s) 302, 322.

The electronic storage 306, 326 may include non-transitory storage media that electronically stores information. The electronic storage media of electronic storage 306, 326 may include one or both of system storage that is provided integrally (i.e., substantially non-removable) with the computing devices 202, 204 and/or removable storage that is removably connectable to the computing devices 202, 204 via, for example, a port (e.g., a universal serial bus (USB) port, a firewire port, etc.) or a drive (e.g., a disk drive, etc.). Electronic storage 306, 326 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 306, 326 may include one or more virtual storage resources (e.g., cloud storage, a virtual private network, and/or other virtual storage resources). Electronic storage 306, 326 may store software algorithms, information determined by processing system(s) 302, 322, information received from the computing devices 202, 204 or other information that enables the computing devices 202, 204 to function as described herein. For example, the electronic storage 306, 326 may store the modules 308–316.

Processing system(s) 302, 322 may be configured to provide information processing capabilities in the computing devices 202, 204. As such, the processing system(s) 302, 322 may include one or more of a digital processor, an analog processor, a digital circuit designed to process information, an analog circuit designed to process information, a state machine, and/or other mechanisms for electronically processing information. Although the processing system(s) 302, 322 are illustrated as single entities, this is for illustrative purposes only. In some embodiments, the processing system(s) 302, 322 may include a plurality of processing units and/or processor cores. The processing units may be physically located within the same device, or processing system(s) 302, 322 may represent processing functionality of a plurality of devices operating in coordination. The processing system(s) 302, 322 may be configured to execute modules 308–316 and/or other modules by software; hardware; firmware; some combination of software, hardware, and/or firmware; and/or other mechanisms for configuring processing capabilities on processing system(s) 302, 322. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 308–316 is for illustrative purposes, and is not intended to be limiting, as any of modules 308–316 may provide more or less functionality than is described. For example, one or more of the modules 308–316 may be eliminated, and some or all of its functionality may be provided by other modules 308–316. As another example, the processing system(s) 302, 322 may be configured to execute one or more additional modules that may perform some or all of the functionality attributed below to one of the modules 308–316.

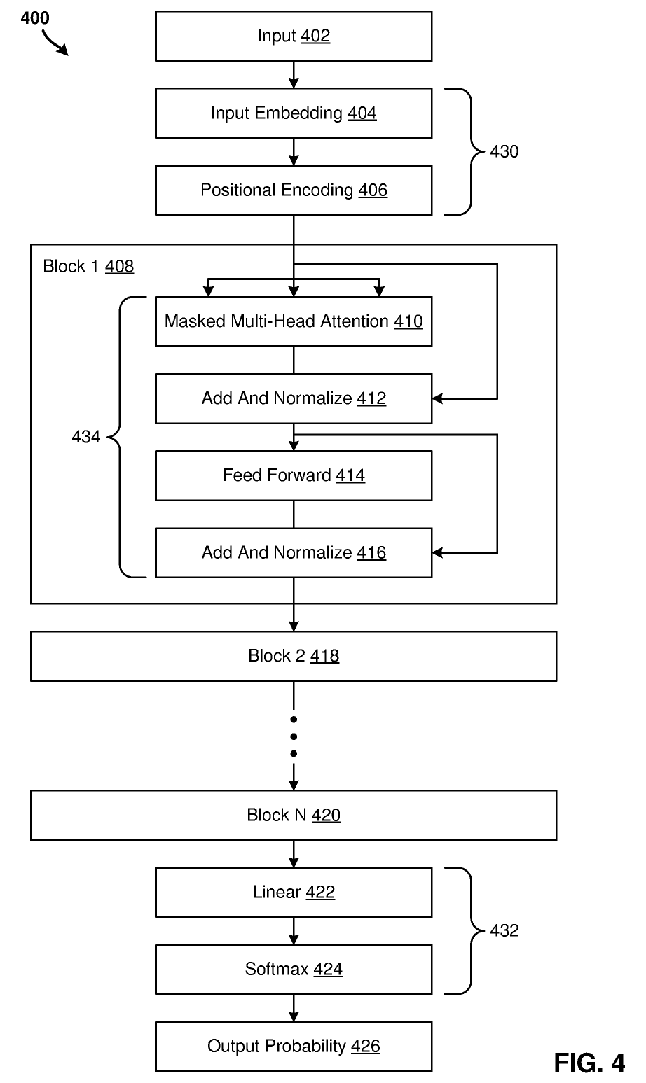

FIG. 4 is a block diagram illustrating an example neural network architecture 400 suitable for use in accordance with some embodiments. With reference to FIGS. 1-4, the neural network architecture 400 may be an LXM that may be implemented on one or more processing systems (e.g., SIP 100, SoC 102, 104, processor 110, 112, 114, 116, 118, 121, 122, 121, 122, 152, 160, processing system 302, 322 in FIGS. 1, 3A and 3B) on one or more computing devices (e.g., computing device 202, 204 in FIGS. 2-3B). The LXM 400 in FIG. 4 may be an LLM and a non-limiting example of an LXM 400, which may be any other type of LXM.

The LXM 400 may include one or more input layers 430, multiple decoder layers 434, and one or more output layers 432. The one or more input layers 430 may include, for example, an input embedding layer 404 and/or a positional encoding layer 406. The one or more output layers 432, may include, for example, a linear layer 422, and/or a softmax layer 424. The softmax function is a function that turns a vector of K real values into a vector of K real values that sum to 1. The input values can be positive, negative, zero, or greater than one, but the softmax transforms them into values between 0 and 1, so that they can be interpreted as probabilities.

The one or more decoder layers 434 may be grouped into one or more decoder blocks 408, 418, 420. Each decoder block 408, 418, 420 may include the same or different decoder layers 434. The decoder layers 434 may include, for example, one or more of any combination of a masked multi-head attention layer 410, add and normalization layer 412, 416, and/or feed forward layer 414.

The LXM 400 may receive an input 402 into the one or more input layers 430. The input 402 may be any form of data including data representing text, images, video, sound, etc. The input 402 may be divided into input chunks of an input chunk size such that the input 402 is divided into smaller, sequential parts. The input 402 may be provided as sequential input chunks, such that each input chunk may be an input 402, to the LXM 400. The input embedding layer 404 may convert the input 402 into a data format, such as vectors, that the LXM 400 may process. The positional encoding layer 406 may add information about the position of aspects of the input 402 in a sequence that may aid the LXM 400 understand the order of the aspects of the input 402.

The input chunks processed by the input layers 430 may be provided to the decoder layers 434 and/or decoder blocks 408, 418, 420. The masked multi-head attention layer 410 may implement various different functions on the input 402 and combine the results while masking future chunks from the functions. The add and normalization layer 412 may normalize the input 402 and add residual connections that may maintain a consistent scale of the data. The feed forward layer 414 may apply a fully connected neural network to the different aspects of the input 402. The add and normalization layer 416 may again normalize the input 402 and add residual connections that may maintain a consistent scale of the data. The output of any of the decoder layers 434 and/or decoder blocks 408, 418, 420 may be referred to as an intermediary chunk.

The output of the final decoder layers 434 and/or decoder block 420, intermediary chunks, may be provided to the output layers 432. The linear layer 422 may apply a linear transformation to the intermediary chunks. The softmax layer 424 may convert the result of the linear functions into probabilities 426. The output of any of the output layers 432 may be referred to as an output chunk.

The layers 404-424 are used for illustrative purposes and do not limit the input layers 430, decoder layers 434, and output layers 432 to these specific examples. It should be understood that the input layers 430, decoder layers 434, and output layers 432 may include various other combinations of layers for other configurations of the LXM 400.

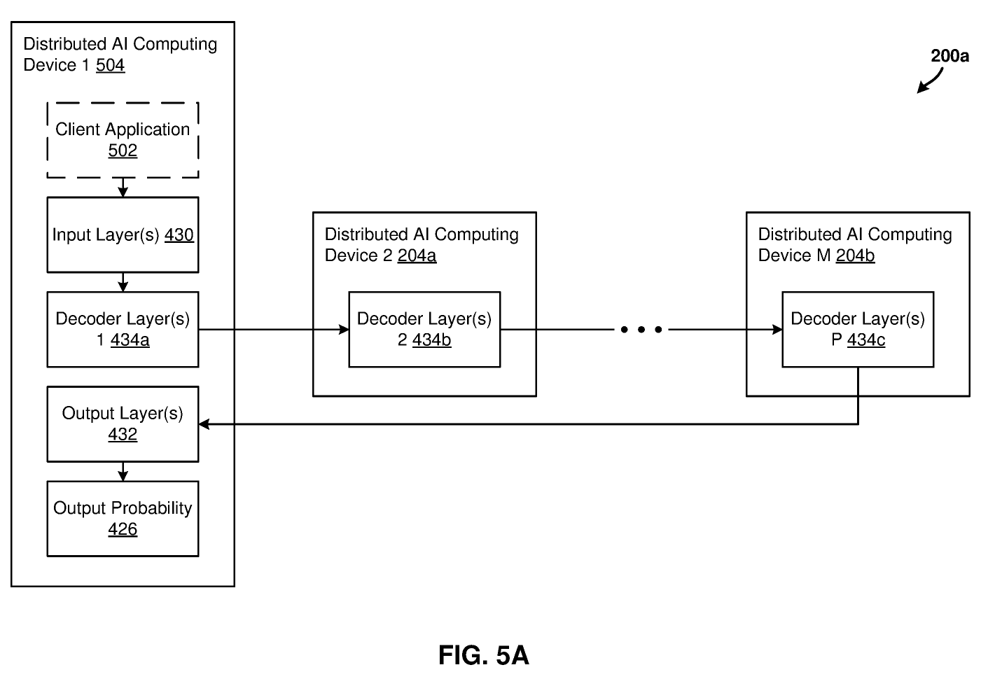

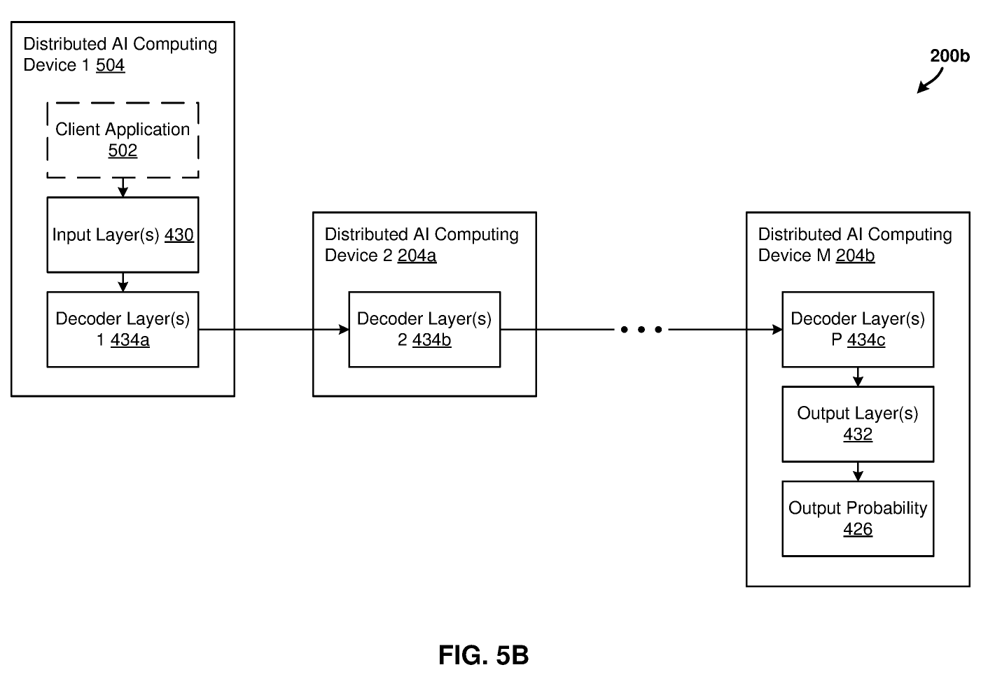

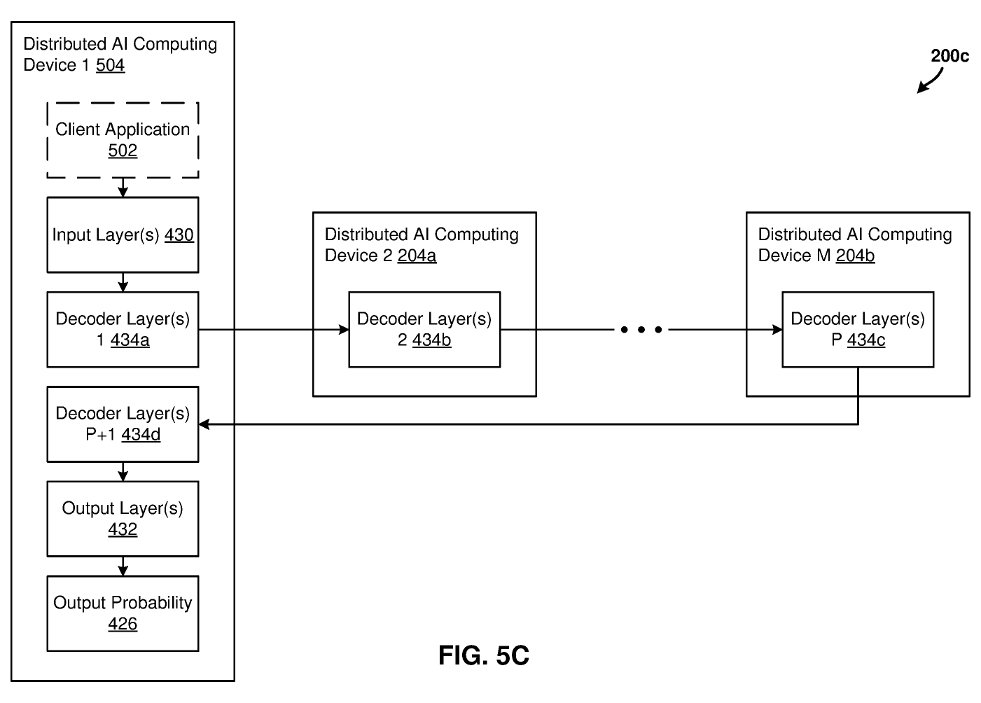

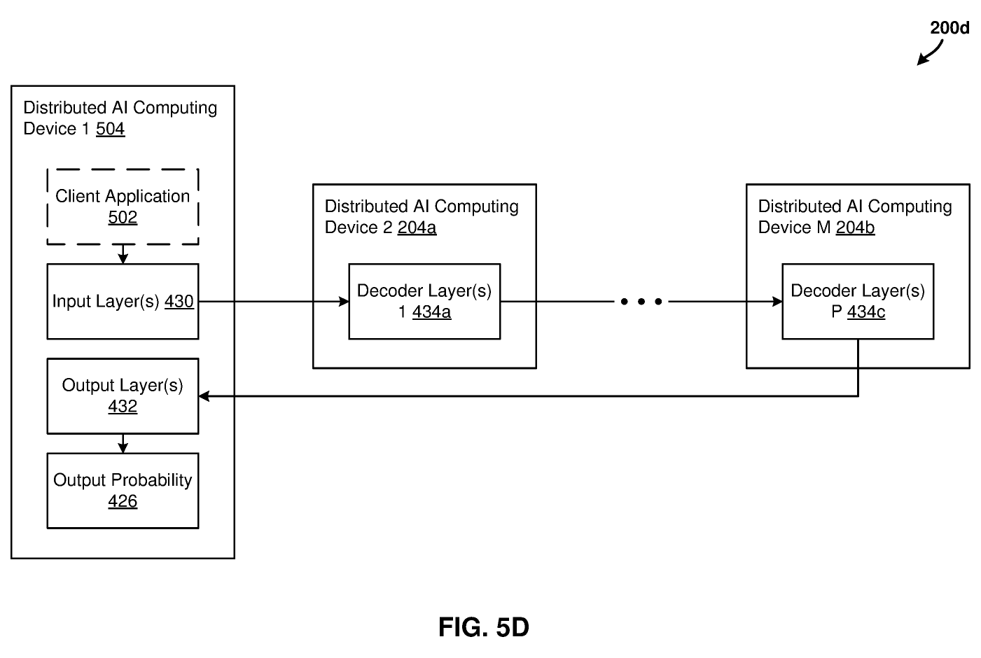

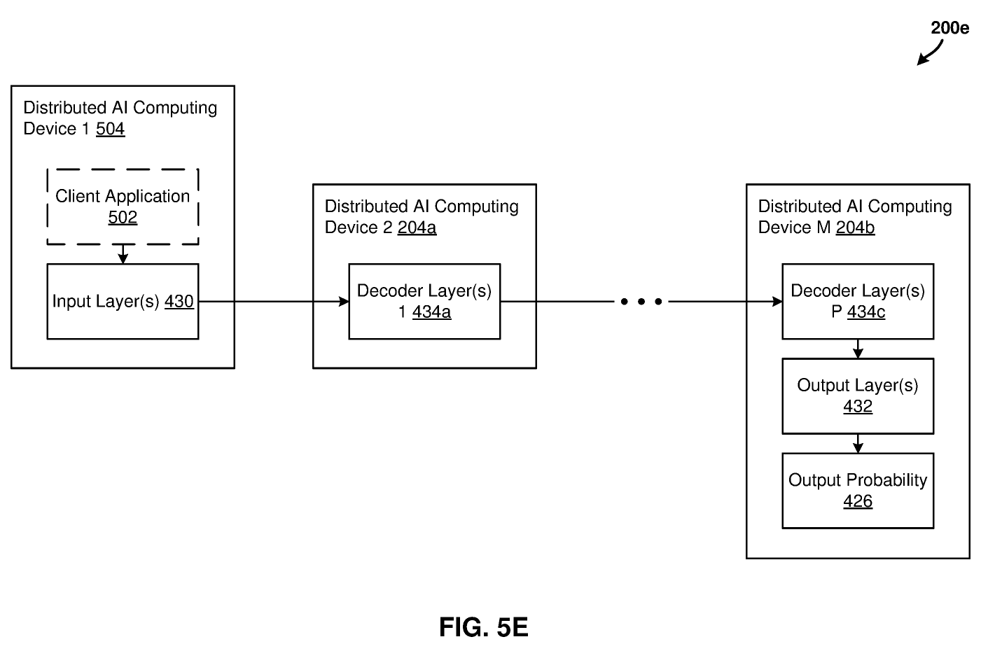

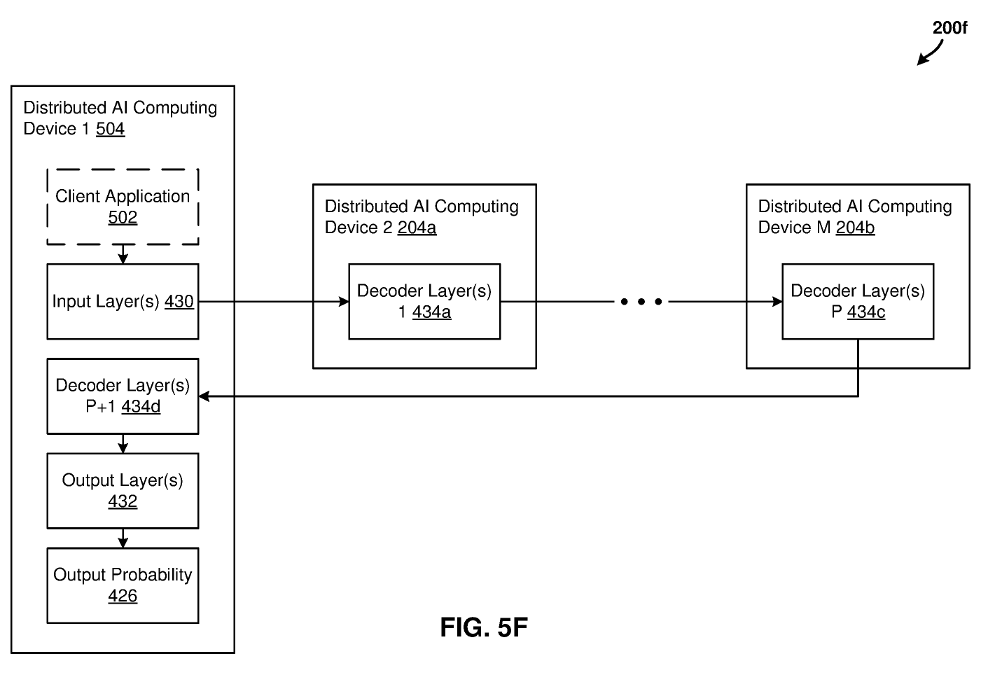

FIGS. 5A-5F are block diagrams illustrating examples of an LXM distribution across computing devices 204a, 204b, 504 (e.g., computing devices 202, 204 in FIGS. 2-3B) of a distributed AI computing system 200a, 200b, 200c, 200d, 200e, 200f (e.g., distributed AI computing system 200 in FIGS. 2-3B) in accordance with some embodiments. With reference to FIGS. 1-5F, the computing devices 204a, 204b, 504 may be configured to implement various parts of the distributed LXM (e.g., LXM 400 in FIG. 4), including the input layers 430, the decoder layers 434a, 434b, 434c (e.g., decoder layers 410, 412, 414, 416, 434 in FIG. 4), and/or output layers 432. Each of the computing devices 202, 506, 508a, 508b may include one or more processing systems including one or more processors coupled to at least one memory (e.g., SIP 100, SoC 102, 104, processor 110, 112, 114, 116, 118, 121, 122, 121, 122, 152, 160, processing system 302, 322 in FIGS. 1, 3A, and 3B) configured to implement the parts of the distributed LXM. The processing systems of the initial distributed AI computing device 504 may also be configured to implement a client application 502.

In some embodiments, any of the distributed AI computing system 200a, 200b, 200c, 200d, 200e, 200f the initial distributed AI computing device 504 may be optionally configured to implement the client application 502. In some embodiments, the client application 502 may be implemented by a distributed AI computing device 204a, 204b or another computing device (not shown) communication connected to the initial distributed AI computing device 504.

With reference to the distributed AI computing systems 200a, the initial distributed AI computing device 504 may be configured to implement an allocated portion of the distributed LXM including any combination of the one or more input layers 430, the one or more decoder layers 434a, and the one or more output layers 432. The distributed AI computing devices 204a, 204b may each be configured to implement allocated portions of the distributed LXM including one or more decoder layers 434b, 434c. The initial distributed AI computing device 504 may be configured to divide an input (e.g., input 402 in FIG. 4) to the distributed LXM into input chunks of the input chunk size.

In response to a prompt from the client application 502, which may also provide the input, the initial distributed AI computing device 504 may implement the distributed LXM by batch processing the input chunks of the input. The initial distributed AI computing device 504 may process a first input chunk by executing an allocated portion of the distributed LXM, the one or more input layers 430 and the one or more decoder layers 434a, generating a first intermediary chunk, and transmitting the first intermediary chunk to the distributed AI computing device 204a.

In parallel with transmitting the first intermediary chunk, the initial distributed AI computing device 504 may process a second input chunk generating a second intermediary chunk. In parallel with the initial distributed AI computing device 504 processing the second input chunk, the distributed AI computing device 204a may process the first intermediary chunk by executing an allocated portion of the distributed LXM, the one or more decoder layers 434b, generating a third intermediary chunk, and transmitting the third intermediary chunk to the distributed AI computing device 204b.

In parallel with transmitting the third intermediary chunk, the initial distributed AI computing device 504 may process a remaining subsequent input chunk, and the distributed AI computing device 204a may process the second intermediary chunk. In parallel with the initial distributed AI computing device 504 processing the remaining subsequent input chunk and the distributed AI computing device 204a processing the second intermediary chunk, the distributed AI computing device 204b may process the third intermediary chunk by executing an allocated portion of the distributed LXM, the one or more decoder layers 434c, generating a fourth intermediary chunk. The distributed AI computing device 204b may transmit the fourth intermediary chunk to the initial distributed AI computing device 504.

In parallel with transmitting the fourth intermediary chunk, the initial distributed AI computing device 504 may process a remaining subsequent input chunk, and the distributed AI computing devices 204a, 204b may process remaining intermediary chunks. In parallel with the initial distributed AI computing device 504 processing the remaining subsequent input chunk, and the distributed AI computing devices 204a, 204b processing remaining intermediary chunks, the initial distributed AI computing device 504 may process the fourth intermediary chunk by executing the one or more output layers 432, generating an output probability 426, or output chunk.

With reference to the distributed AI computing system 200b, the initial distributed AI computing device 504 may be configured to implement the allocated portion of the distributed LXM including the one or more input layers 430 and the one or more decoder layers 434a. The distributed AI computing device 204a may be configured to implement an allocated portion of the distributed LXM including one or more decoder layers 434b. The distributed AI computing device 204c may be configured to implement an allocated portions of the distributed LXM including one or more decoder layers 434c and the one or more output layers 432. The initial distributed AI computing device 504 may be configured to divide an input (e.g., input 402 in FIG. 4) to the distributed LXM into input chunks of the input chunk size.

The initial distributed AI computing device 504 implementing the allocated portion of the distributed LXM, the one or more input layers 430 and the one or more decoder layers 434a, may be implemented as described with reference to the distributed AI computing system 200a. Similarly, the distributed AI computing device 204a implementing the allocated portion of the distributed LXM, the one or more decoder layers 434b, may be implemented as described with reference to the distributed AI computing system 200a.

In parallel with the initial distributed AI computing device 504 processing a remaining subsequent input chunk and the distributed AI computing device 204a processing a second intermediary chunk, the distributed AI computing device 204c may process the third intermediary chunk by executing an allocated portion of the distributed LXM, the one or more decoder layers 434c, generating a fourth intermediary chunk.

In parallel with the initial distributed AI computing device 504 processing a remaining subsequent input chunk, and the distributed AI computing devices 204a, 204c processing remaining intermediary chunks, the distributed AI computing device 204c may process the fourth intermediary chunk by executing the one or more output layers 432, generating an output probability 426, or output chunk.

With reference to the distributed AI computing system 200c, the initial distributed AI computing device 504 may be configured to implement the allocated portion of the distributed LXM including the one or more input layers 430, the one or more decoder layers 434a, 434d, and the one or more output layers 432. The distributed AI computing device 204a may be configured to implement an allocated portion of the distributed LXM including one or more decoder layers 434b. The distributed AI computing device 204c may be configured to implement an allocated portion of the distributed LXM including one or more decoder layers 434c. The initial distributed AI computing device 504 may be configured to divide an input (e.g., input 402 in FIG. 4) to the distributed LXM into input chunks of the input chunk size.

The initial distributed AI computing device 504 implementing the allocated portion of the distributed LXM, the one or more input layers 430 and the one or more decoder layers 434a, may be implemented as described with reference to the distributed AI computing system 200a. Similarly, the distributed AI computing devices 204a, 204b implementing the allocated portion of the distributed LXM, the one or more decoder layers 434b, 434c, may be implemented as described with reference to the distributed AI computing system 200a.

In parallel with the distributed AI computing devices 204b transmitting the fourth intermediary chunk, the initial distributed AI computing device 504 may process remaining subsequent input chunks, and the distributed AI computing devices 204a, 204b may process remaining intermediary chunks. In parallel with the initial distributed AI computing device 504 processing the remaining subsequent input chunks, and the distributed AI computing devices 204a, 204b processing remaining intermediary chunks, the initial distributed AI computing device 504 may process the fourth intermediary chunk by executing an allocated portion of the distributed LXM, the one or more decoder layers 434d, generating a fifth intermediary chunk. In parallel with the initial distributed AI computing device 504 processing remaining subsequent input chunks and remaining intermediary chunks, and the distributed AI computing devices 204a, 204b processing remaining intermediary chunks, the initial distributed AI computing device 504 may process the fifth intermediary chunk by executing the one or more output layers 432, generating an output probability 426, or output chunk.

With reference to the distributed AI computing system 200d, the initial distributed AI computing device 504 may be configured to implement an allocated portion of the distributed LXM including the one or more input layers 430 and the one or more output layers 432. The distributed AI computing devices 204a, 204b may each be configured to implement allocated portions of the distributed LXM including one or more decoder layers 434b, 434c. The initial distributed AI computing device 504 may be configured to divide an input (e.g., input 402 in FIG. 4) to the distributed LXM into input chunks of the input chunk size.

In response to a prompt from the client application 502, which may also provide the input, the initial distributed AI computing device 504 may implement the distributed LXM by batch processing the input chunks of the input. The initial distributed AI computing device 504 may process a first input chunk by executing the one or more input layers 430 generating a first intermediary chunk, and transmitting the first intermediary chunk to the distributed AI computing device 204a.

In parallel with transmitting the first intermediary chunk, the initial distributed AI computing device 504 may process a second input chunk generating a second intermediary chunk. In parallel with the initial distributed AI computing device 504 processing the second input chunk, the distributed AI computing device 204a may process the first intermediary chunk by executing an allocated portion of the distributed LXM, the one or more decoder layers 434b, generating a third intermediary chunk, and transmitting the third intermediary chunk to the distributed AI computing device 204b.

In parallel with transmitting the third intermediary chunk, the initial distributed AI computing device 504 may process a remaining subsequent input chunk, and the distributed AI computing device 204a may process the second intermediary chunk. In parallel with the initial distributed AI computing device 504 processing the remaining subsequent input chunk and the distributed AI computing device 204a processing the second intermediary chunk, the distributed AI computing device 204b may process the third intermediary chunk by executing an allocated portion of the distributed LXM, the one or more decoder layers 434c, generating a fourth intermediary chunk. The distributed AI computing device 204b may transmit the fourth intermediary chunk to the initial distributed AI computing device 504.

In parallel with transmitting the fourth intermediary chunk, the initial distributed AI computing device 504 may process a remaining subsequent input chunk, and the distributed AI computing devices 204a, 204b may process remaining intermediary chunks. In parallel with the initial distributed AI computing device 504 processing the remaining subsequent input chunk, and the distributed AI computing devices 204a, 204b processing remaining intermediary chunks, the initial distributed AI computing device 504 may process the fourth intermediary chunk by executing the one or more output layers 432, generating an output probability 426, or output chunk.

With reference to the distributed AI computing system 200e, the initial distributed AI computing device 504 may be configured to implement an allocated portion of the distributed LXM including the one or more input layers 430. The distributed AI computing device 204a may be configured to implement an allocated portion of the distributed LXM including one or more decoder layers 434b. The distributed AI computing device 204c may be configured to implement an allocated portions of the distributed LXM including one or more decoder layers 434c and the one or more output layers 432. The initial distributed AI computing device 504 may be configured to divide an input (e.g., input 402 in FIG. 4) to the distributed LXM into input chunks of the input chunk size.

The initial distributed AI computing device 504 implementing the one or more input layers 430 may be implemented as described with reference to the distributed AI computing system 200d. Similarly, the distributed AI computing device 204a implementing the allocated portion of the distributed LXM, the one or more decoder layers 434b, may be implemented as described with reference to the distributed AI computing system 200d.

In parallel with the initial distributed AI computing device 504 processing a remaining subsequent input chunk and the distributed AI computing device 204a processing a second intermediary chunk, the distributed AI computing device 204c may process the third intermediary chunk by executing an allocated portion of the distributed LXM, the one or more decoder layers 434c, generating a fourth intermediary chunk.

In parallel with the initial distributed AI computing device 504 processing a remaining subsequent input chunk, and the distributed AI computing devices 204a, 204c processing remaining intermediary chunks, the distributed AI computing device 204c may process the fourth intermediary chunk by executing the one or more output layers 432, generating an output probability 426, or output chunk.

With reference to the distributed AI computing system 200f, the initial distributed AI computing device 504 may be configured to implement the allocated portion of the distributed LXM including the one or more input layers 430, the one or more decoder layers 434d, and the one or more output layers 432. The distributed AI computing device 204a may be configured to implement an allocated portion of the distributed LXM including one or more decoder layers 434b. The distributed AI computing device 204c may be configured to implement an allocated portion of the distributed LXM including one or more decoder layers 434c. The initial distributed AI computing device 504 may be configured to divide an input (e.g., input 402 in FIG. 4) to the distributed LXM into input chunks of the input chunk size.

The initial distributed AI computing device 504 implementing the one or more input layers 430 may be implemented as described with reference to the distributed AI computing system 200d. Similarly, the distributed AI computing devices 204a, 204b implementing the allocated portion of the distributed LXM, the one or more decoder layers 434b, 434c, may be implemented as described with reference to the distributed AI computing system 200d.

In parallel with the distributed AI computing devices 204b transmitting the fourth intermediary chunk, the initial distributed AI computing device 504 may process remaining subsequent input chunks, and the distributed AI computing devices 204a, 204b may process remaining intermediary chunks. In parallel with the initial distributed AI computing device 504 processing the remaining subsequent input chunks, and the distributed AI computing devices 204a, 204b processing remaining intermediary chunks, the initial distributed AI computing device 504 may process the fourth intermediary chunk by executing an allocated portion of the distributed LXM, the one or more decoder layers 434d, generating a fifth intermediary chunk. In parallel with the initial distributed AI computing device 504 processing remaining subsequent input chunks and remaining intermediary chunks, and the distributed AI computing devices 204a, 204b processing remaining intermediary chunks, the initial distributed AI computing device 504 may process the fifth intermediary chunk by executing the one or more output layers 432, generating an output probability 426, or output chunk.

In the foregoing examples, existing remaining input chunks and remaining intermediary chunks may be processed. The foregoing examples may be similarly implemented without implementing processing for nonexistent remaining input chunks.

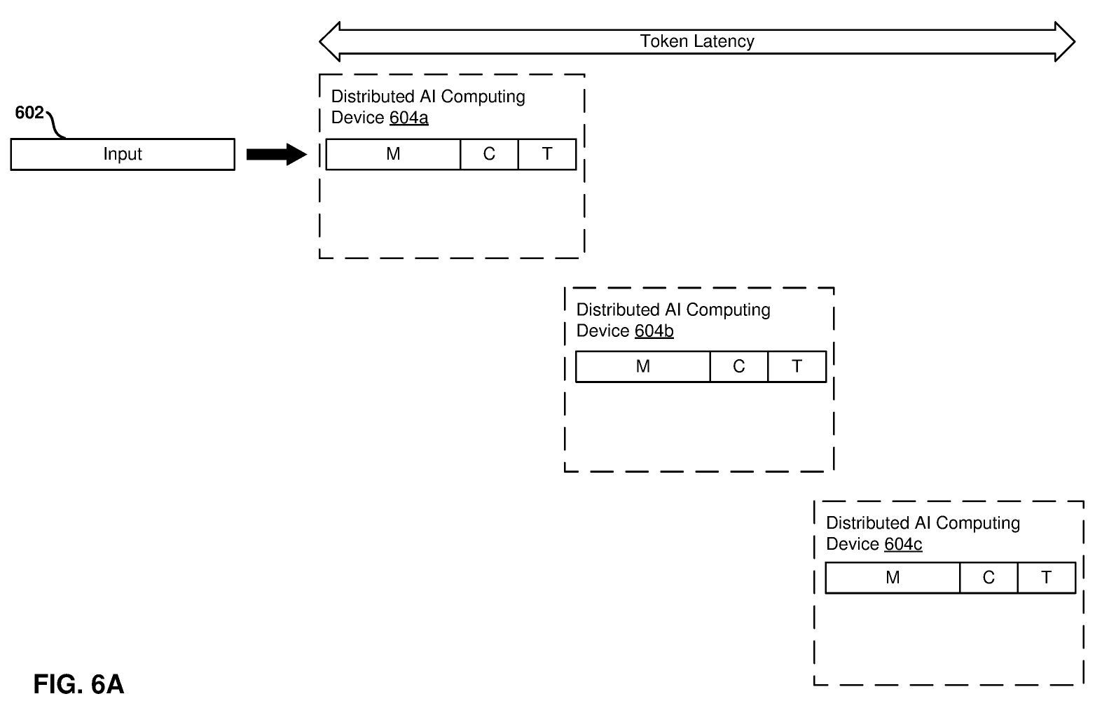

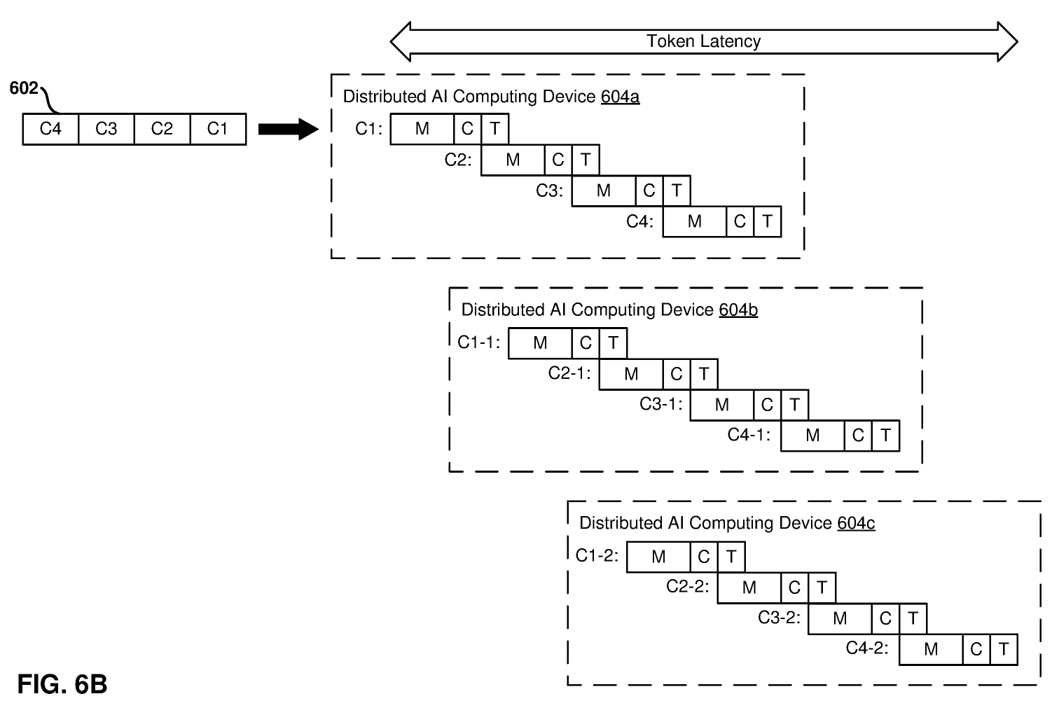

FIG. 6A is a block diagram illustrating LXM input processing in an LXM distribution across computing devices 604a, 604b, 604c (e.g., computing devices 202, 204, 204a, 204b, 504 in FIGS. 2-3B, 5A-5F) of a distributed AI computing system (e.g., distributed AI computing system 200, 200a, 200b, 200c, 200d, 200e, 200f in FIGS. 2-3B, 5A-5F) in accordance with some embodiments. With reference to FIGS. 1-6A, an input 602 (e.g., input 402 in FIG. 4) may be input in batches to a distributed LXM (e.g., LXM 400 in FIG. 4) distributed across the computing devices 604a, 604b, 604c, and processed, generating intermediary chunks. Processing of the input and the intermediary chunks may take time, including a memory I/O latency time (M), a compute time (C), and a time for transmission between computing devices 604a, 604b, 604c (T).

The input may be processed by the distributed AI computing device 604a implementing an allocated portion of the distributed LXM including one or more input layers (e.g., embedding layer 404, positional encoding layer 406, input layer 430 in FIGS. 4-5F) and/or one or more decoder layers (e.g., decoder layers 410, 412, 414, 416, 434, 434a, 434b, 434c, 434d in FIGS. 4-5F). Processing the input 602 may generate intermediary chunks. The memory and compute operations for processing the input may be implemented serially. The transmission operations for transmitting the intermediary chunks may occur serially with the memory and/or compute operations for processing the input.

The intermediary chunks may be processed by a distributed AI computing device 604b implementing an allocated portion of the distributed LXM including one or more decoder layers. Processing the intermediary chunks may generate further intermediary chunks. The memory and compute operations for processing the intermediary chunks may be implemented serially. The transmission operations for transmitting the intermediary chunks may occur serially with the memory and/or compute operations for processing the intermediary chunks. Memory, compute, and transmission operations implemented by the distributed AI computing device 604b may be implemented serially with memory, compute, and transmission operations implemented by the distributed AI computing device 604a.

The intermediary chunks may be processed by a distributed AI computing device 604c implementing an allocated portion of the distributed LXM including one or more decoder layers. Processing the intermediary chunks may generate further intermediary chunks (not shown). The memory and compute operations for processing the intermediary chunks may be implemented serially. The transmission operations for transmitting the further intermediary chunks may occur serially with the memory and/or compute operations for processing the intermediary chunks. Memory, compute, and transmission operations implemented by the distributed AI computing device 604c may be implemented serially with memory, compute, and transmission operations implemented by the distributed AI computing device 604b.

FIG. 6B is a block diagram illustrating LXM input chunking and chunk parallel processing in an LXM distribution across computing devices 604a, 604b, 604c (e.g., computing devices 202, 204, 204a, 204b, 504 in FIGS. 2-3B, 5A-5F) of a distributed AI computing system (e.g., distributed AI computing system 200, 200a, 200b, 200c, 200d, 200e, 200f in FIGS. 2-3B, 5A-5F) in accordance with some embodiments. With reference to FIGS. 1-6, an input 602 (e.g., input 402 in FIG. 4) may be divided into input chunks (e.g., C1, C2, C3, C4) of an input chunk size. The input chunks may be input in batches to a distributed LXM (e.g., LXM 400 in FIG. 4) distributed across the computing devices 604a, 604b, 604c, and processed, generating intermediary chunks (e.g., C1-1, C2-1, C3-1, C4-1, C1-2, C2-2, C3-2, C4-2). Processing of input and intermediary chunks may take time, including a memory I/O latency time (M), a compute time (C), and a time for transmission between computing devices 604a, 604b, 604c (T).

The input chunks may be processed by the distributed AI computing device 604a implementing an allocated portion of the distributed LXM including one or more input layers (e.g., embedding layer 404, positional encoding layer 406, input layer 430 in FIGS. 4-5F) and/or one or more decoder layers (e.g., decoder layers 410, 412, 414, 416, 434, 434a, 434b, 434c, 434d in FIGS. 4-5F). Processing the input chunks may generate intermediary chunks (e.g., C1-1, C2-1, C3-1, C4-1). The memory and compute operations for processing the input chunks may be implemented serially. The transmission operations for transmitting the intermediary chunks may occur in parallel with the memory and/or compute operations for processing the input chunks.

The intermediary chunks (e.g., C1-1, C2-1, C3-1, C4-1) may be processed by a distributed AI computing device 604b implementing an allocated portion of the distributed LXM including one or more decoder layers. Processing the intermediary chunks (e.g., C1-1, C2-1, C3-1, C4-1) may generate further intermediary chunks (e.g., C1-2, C2-2, C3-2, C4-2). The memory and compute operations for processing the intermediary chunks (e.g., C1-1, C2-1, C3-1, C4-1) may be implemented serially. The transmission operations for transmitting the intermediary chunks (e.g., C1-2, C2-2, C3-2, C4-2) may occur in parallel with the memory and/or compute operations for processing the intermediary chunks (e.g., C1-1, C2-1, C3-1, C4-1). Memory, compute, and transmission operations implemented by the distributed AI computing device 604b may be implemented in parallel with memory, compute, and transmission operations implemented by the distributed AI computing device 604a.

The intermediary chunks (e.g., C1-2, C2-2, C3-2, C4-2) may be processed by a distributed AI computing device 604c implementing an allocated portion of the distributed LXM including one or more decoder layers. Processing the intermediary chunks (e.g., C1-2, C2-2, C3-2, C4-2) may generate further intermediary chunks (not shown). The memory and compute operations for processing the intermediary chunks (e.g., C1-2, C2-2, C3-2, C4-2) may be implemented serially. The transmission operations for transmitting the further intermediary chunks may occur in parallel with the memory and/or compute operations for processing the intermediary chunks (e.g., C1-2, C2-2, C3-2, C4-2). Memory, compute, and transmission operations implemented by the distributed AI computing device 604c may be implemented in parallel with memory, compute, and transmission operations implemented by the distributed AI computing device 604a and/or the distributed AI computing device 604b.

Chunking of the input may enable parallel execution of the memory, compute, and transmission operations implemented by the computing devices 604a, 604b, 640c for implementing the distributed LXM. Leveraging chunking of the input and parallel execution of the operations for implementing the distributed LXM may reduce the token latency as compared to serial processing of a not chunked input in a non-distributed LXM or distributed LXM, as illustrated in FIG. 6A.

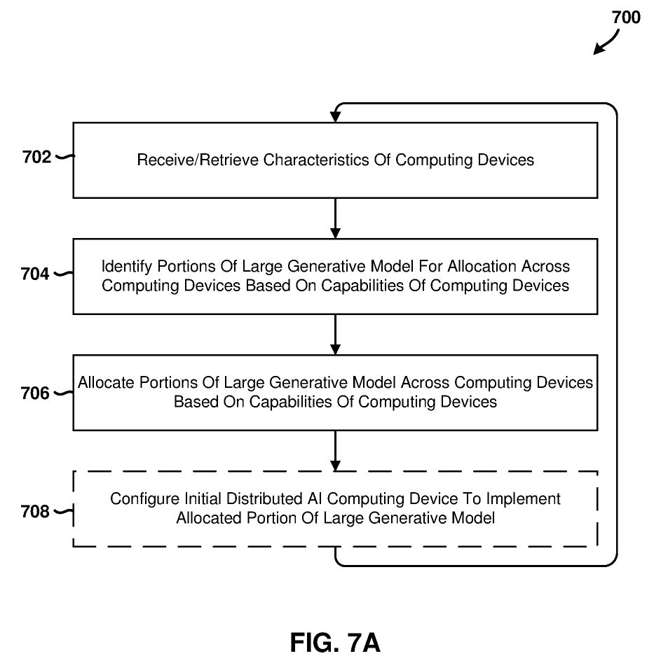

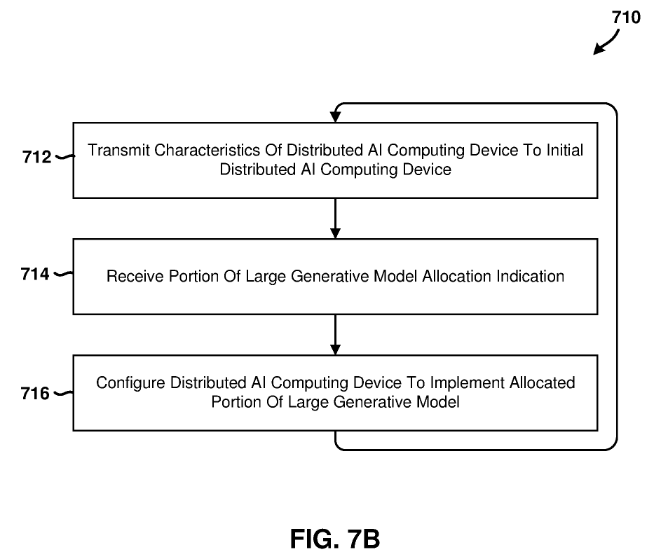

FIGS. 7A and 7B are process flow diagrams illustrating methods 700, 710 for distributing an LXM (e.g., LXM 400 in FIG. 4) across computing devices (e.g., computing devices 202, 204, 204a, 204b, 504, 604a, 604b, 604c in FIGS. 2-3B and 5A-6B) of a distributed AI computing system (e.g., distributed AI computing system 200, 200a, 200b, 200c, 200d, 200e, 200f in FIGS. 2-3B, and 5A-5F) in accordance with some embodiments. With reference to FIGS. 1-7B, the methods 700, 710 may be performed in a computing device by at least one processing system including at least one memory having executable instructions thereon coupled to one or more processors configured to execute the executable instructions (e.g., SIP 100, SoC 102, 104, processor 110, 112, 114, 116, 118, 121, 122, 121, 122, 152, 160, processing system 302, 322 in FIGS. 1, 3A, and 3B) and components (e.g., module 308-316 in FIGS. 3A and 3B) or subsystems discussed in this application. Means for performing the functions of the operations in the methods 700, 710 may include a processing system including one or more processors, at least one memory and other components described herein. Further, one or more processors of a processing system may be configured with software or firmware to perform some or all of the operations of the methods 700, 710. In order to encompass the alternative configurations enabled in various embodiments, the hardware implementing any or all of the methods 700, 710 is referred to herein as a “processor.”

With reference to the method 700, in block 702, the processor may receive or retrieve characteristics of computing devices (e.g., computing devices 202, 204, 204a, 204b, 504, 604a, 604b, 604c in FIGS. 2-3B and 5A-6B). In some embodiments, the processor receiving or retrieving the characteristics of the computing devices in block 702 may include a processing system (e.g., SIP 100, SoC 102, 104, processor 110, 112, 114, 116, 118, 121, 122, 121, 122, 152, 160, processing system 302, 322 in FIGS. 1, 3A and 3B), an LXM distribution module (e.g., LXM distribution module 308 in FIG. 3A), or a TX/RX module (e.g., TX/RX module 314 in FIG. 3A).

Characteristics of computing devices may include characteristics of one or more distributed AI computing devices, which may include an initial distributed AI computing device. The characteristics may be retrieved from a memory (e.g., memory 120, 158, electronic storage 306, 326 in FIGS. 1 and 3A) and/or received from the one or more distributed AI computing devices. The characteristics may include computing device capability and connectivity conditions between computing devices. For example, computing device capability may include available compute capacity, available memory capacity, available memory bandwidth, available power, etc. of each of the computing devices. As another example, connectivity conditions may include available bandwidth, signal strength, signal quality, signal reliability, signal latency, etc. between the computing devices.

In some embodiments, the processor may also retrieve characteristics of the LXM. The characteristics may be retrieved from the memory. Characteristics of the LXM may include varying sizes, complexities, parameters, and/or tokens. For example, the Characteristics of the LXM may include a number of decoder layers, a model dimension size, a number of parameters, a vocabulary size, a max context length, an attention mechanism (e.g., multi-head attention or group query attention), etc. In some embodiments, the processor may also retrieve characteristics of an input to the LXM, such as a token length.

In block 704, the processor may identify portions of the LXM for allocation across the computing devices in which the division is based on the capabilities of the computing devices. In some embodiments, the processor may identify portions of the LXM based further on characteristics of the LXM, which may include a token length. The portions of the LXM may include at least one input layer (e.g., embedding layer 404, positional encoding layer 406, input layer 430 in FIGS. 4-5F), decoder layer (e.g., decoder layer 410, 412, 414, 416, 434, 434a, 434b, 434c, 434d in FIGS. 4-5F), or output layers (e.g., linear layers 422, softmax layer 424, output layers 434 in FIGS. 4-5F) of the LXM. The processor may identify how many input layers, decoder layers, or output layers each computing device may implement while balancing execution time the LXM, or the input layers, the decoder layers, or the output layers, across the computing device. In some embodiments, the processor may identify the portions of the LXM for allocation across the computing devices based on the characteristics of the LXM. In some embodiments, the processor identifying the portions of the LXM for allocation across the computing devices based on the capabilities of the computing devices in block 704 may include the processor or the LXM distribution module.

In block 706, the processor may allocate the portions of the LXM across the computing devices based on the capabilities of the computing devices. Based on identifying how many input layers, decoder layers, or output layers each computing device may be allocated to implement while balancing execution time the LXM, the processor may identify which input layers, decoder layers, or output layers each computing device may be allocated to implement while maintaining the time balance. The processor may generate and transmit or store an indication of the portion of the LXM allocated to each computing device, which may indicate the input layers, decoder layers, or output layers of the portion. For example, the processor may transmit the indication directly to a software or store the indication to the memory of the initial distributed AI computing device. As another example, the processor may transmit one or more indications to one or more distributed AI computing devices via a wireless communication network (e.g., wireless communication networks 206 in FIGS. 2-3B). In some embodiments, the processor allocating the portions of the LXM across the computing devices based on the capabilities of the computing devices in block 706 may include the processor, the LXM distribution module, or the TX/RX module.

In optional block 708, the processor may configure the initial distributed AI computing device to implement an allocated portion of the LXM. The processor may be configured to implement the portion of the LXM allocated to the initial distributed AI computing device and not other portions of the distributed LXM. For example, the processor may receive or retrieve the indication of to the portion of the LXM allocated to the initial distributed AI computing device and enable processing of the one or more input layers, decoder layers, or output of the LXM that are included in the portion. Implementation of configuring the initial distributed AI computing device to implement the allocated portion of the LXM in optional block 708 may be based on whether the initial distributed AI computing device is allocated a portion of the LXM. In some embodiments, the processor configuring the initial distributed AI computing device to implement the allocated portion of the LXM in optional block 708 may include the processor or an LXM configuration module (e.g., LXM configuration module 312 in FIG. 3A).

In some embodiments, the processor may continuously, periodically, or episodically implement blocks 702-708. The processor may execute blocks 702-708 during implementation of the LXM across the computing devices. The processor may dynamically redistribute the LXM across the computing devices during the implementation of the LXM.

With reference to the method 710, in block 712, the processor may transmit the characteristics of a distributed AI computing device to the initial distributed AI computing device. In some embodiments, the processor transmitting the characteristics of a distributed AI computing device to the organ computing device in block 712 may include a processor (e.g., SIP 100, SoC 102, 104, processor 110, 112, 114, 116, 118, 121, 122, 121, 122, 152, 160, processing system 302, 322 in FIGS. 1, 3A, and 3B) or a TX/RX module (e.g., TX/RX module 314 in FIG. 3B).

In block 714, the processor may receive a portion of the LXM allocation indication. The processor may receive the indication from the initial distributed AI computing device configured to indicate the portion of the LXM the distributed AI computing device may implement, including which one or more input layer (e.g., embedding layer 404, positional encoding layer 406, input layer 430 in FIGS. 4-5F), decoder layers (e.g., decoder layer 410, 412, 414, 416, 434, 434a, 434b, 434c, 434d in FIGS. 4-5F), or output layers (e.g., linear layers 422, softmax layer 424, output layers 434 in FIGS. 4-5F). In some embodiments, the processor receiving the portion of the LXM allocation indication in block 714 may include the processing system, the TX/RX module, or an LXM configuration module (e.g., LXM configuration module 312 in FIG. 3B).

In block 716, the processor may configure the distributed AI computing device to implement the allocated portion of the LXM. The processor may be configured to implement the portion of the LXM allocated to the distributed AI computing device and not other portions of the distributed LXM. For example, the processor may receive or retrieve the indication of to the portion of the LXM allocated to the distributed AI computing device and enable processing of the one or more input layers, decoder layers, or output layers of the LXM that are included in the portion. In some embodiments, the processor configuring the distributed AI computing device to implement the allocated portion of the LXM in block 716 may include the processor or the LXM configuration module.

In some embodiments, the processor may continuously, periodically, or episodically implement blocks 712-716. The processor may execute blocks 712-716 during implementation of the LXM across the computing devices. The processor may dynamically redistribute the LXM across the computing devices during the implementation of the LXM.

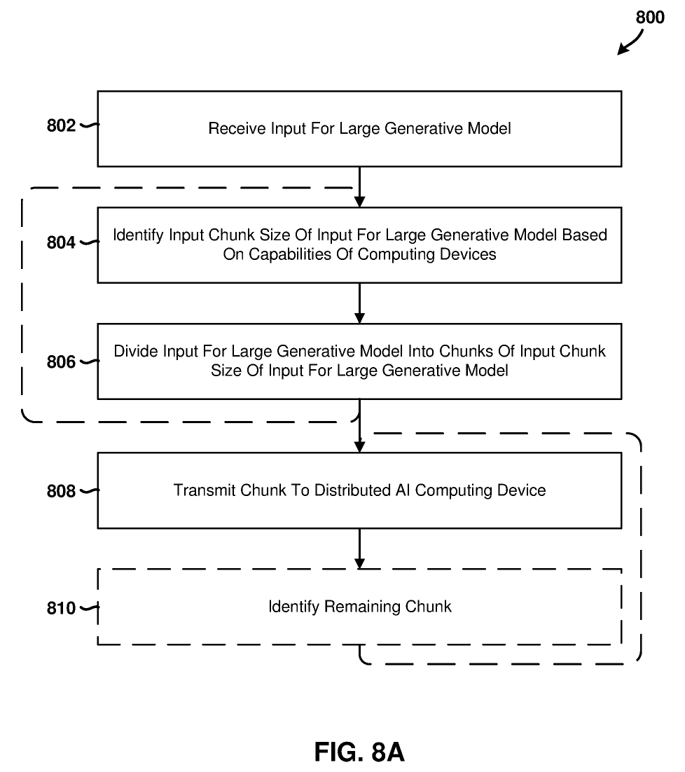

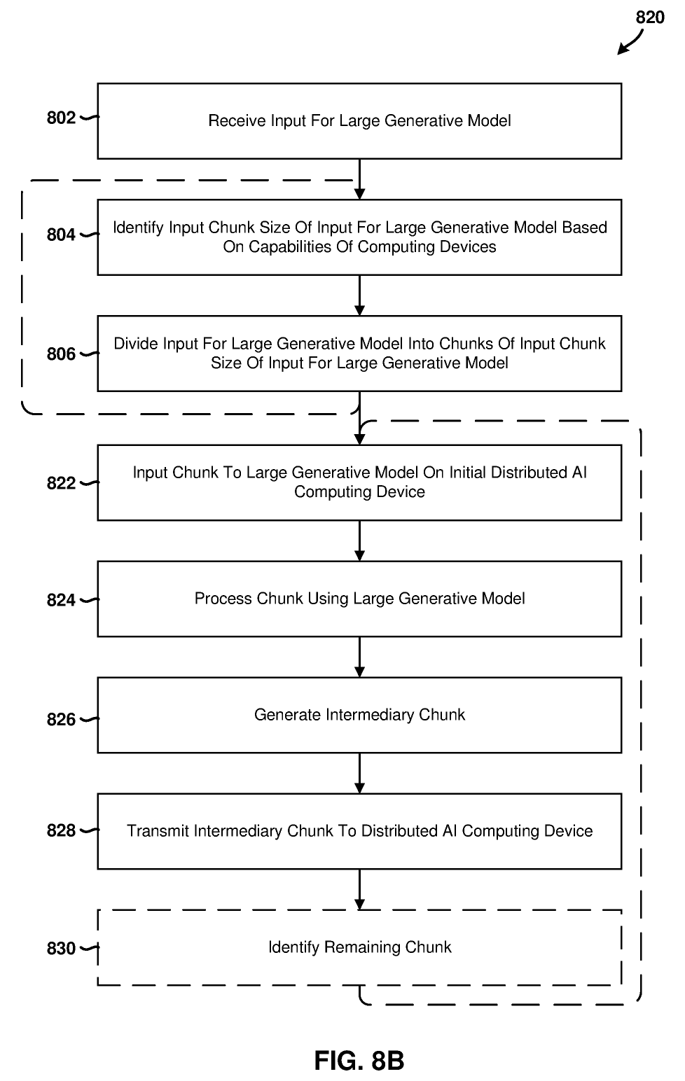

FIGS. 8A and 8B are process flow diagrams illustrating methods 800, 820 for implementing an LXM (e.g., LXM 400 in FIG. 4) distributed across a cluster of computing devices (e.g., computing device 202, 204, 204a, 204b, 504, 604a, 604b, 604c in FIGS. 2-3B and 5A-6B) of a distributed AI computing system (e.g., distributed AI computing system 200, 200a, 200b, 200c, 200d, 200e, 200f in FIGS. 2-3B, 5A-5F) in accordance with some embodiments. With reference to FIGS. 1-8B, the methods 800, 820 may be performed in a computing device by at least one processing system including at least one memory having executable instructions thereon coupled to one or more processors configured to execute the executable instructions (e.g., SIP 100, SoC 102, 104, processor 110, 112, 114, 116, 118, 121, 122, 121, 122, 152, 160, processing system 302, 322 in FIGS. 1, 3A and 3B) and components (e.g., module 308-316 in FIGS. 3A and 3B) or subsystems discussed in this application. Means for performing the functions of the operations in the methods 800, 820 may include a processing system including one or more processors, at least one memory and other components described herein. Further, one or more processors of a processing system may be configured with software or firmware to perform some or all of the operations of the methods 800, 820. In order to encompass the alternative configurations enabled in various embodiments, the hardware implementing any or all of the methods 800, 820 is referred to herein as a “processor.”

With reference to the method 800, in block 802, the processor may receive an input token (e.g., input 402, 602 in FIGS. 4, 6A, and 6B) for the LXM. The input token may be for any form of data including data representing text, images, video, sound, etc. In some embodiments, the processor receiving the input token for the LXM in block 802 may include a processing system (e.g., SIP 100, SoC 102, 104, processor 110, 112, 114, 116, 118, 121, 122, 121, 122, 152, 160, processing system 302, 322 in FIGS. 1, 3A, and 3B) or an input chunking module (e.g., input chunking module 310 in FIG. 3A).

In block 804, the processor may identify an input chunk size of the input token for the LXM based on capabilities of the computing devices (e.g., computing devices 202, 204, 204a, 204b, 504, 604a, 604b, 604c in FIGS. 2-3B and 5A-6B). In some embodiments, the processor receiving the input token for the LXM in block 804 may include the processor or the input chunking module. The input chunk size may be identified based on various parameters. Some parameters may include the characteristics of the computing devices and/or of the LXM. Characteristics of the computing devices may include computing device capability and connectivity conditions between computing devices. For example, computing device capability may include available compute capacity, available memory capacity, available memory bandwidth, available power, operating mode of the processors (e.g., CPU mode, neural processing unit (NPU) mode, etc.), etc. of each of the computing devices. As another example, connectivity conditions may include available bandwidth, signal strength, signal quality, signal reliability, signal latency, etc. between the computing devices. Characteristics of the LXM may include varying sizes, complexities, parameters, and/or token, such as token length during a prefill phase and a decode phase. For example, the Characteristics of the LXM may include a number of input layers, decoder layers, or output layers, a model dimension size, a number of parameters, a vocabulary size, a max context length, an attention mechanism (e.g., multi-head attention or group query attention), etc.

In some embodiments, the processor may identify, such as by estimation or calculation, a metric for implementing the distributed LXM across the computing device. The input chunk size may be identified to achieve various metrics. For example, input chunk size may be identified to achieve reduced token latency.

In block 806, the processor may divide the input token for the LXM into input chunks (e.g., C1, C2, C3, C4 in FIG. 6B) of the input chunk size of the input token for the LXM. Based on the identification of the input chunk size, the processor may divide the input token to the LXM into input chunks of the input chunk size. In some embodiments, the processor dividing the input token for the LXM into the input chunks of the input chunk size of the input token for the LXM in block 806 may include the processor or the input chunking module.

In some embodiments, the input chunking of blocks 804 and 806 may be continuously, periodically, or episodically implemented. The input chunking may be executed during implementation of an LXM across the computing devices. The processor may dynamically reidentify an input chunk size and divide a remaining part of the input token during the implementation of the LXM.

In block 808, the processor may transmit the input chunk to a distributed AI computing device. In some embodiments, the processor may transmit the input chunk directed to a specific distributed AI computing device configured to implement a next portion of the distributed LXM or broadcast the input chunk to multiple distributed AI computing devices. Broadcasting the input chunk may enable dynamic redistribution of the LXM across the distributed AI computing devices during execution of the LXM for an input. Broadcasting the input chunk may provide any distributed AI computing device configured to implement a portion of the LXM after execution of the LXM for the input has commenced with the appropriate input chunk for processing. In some embodiments, the processor transmitting the input chunk to the distributed AI computing device in block 808 may include the processor or a TX/RX module (e.g., TX/RX module 314 in FIG. 3A).

In optional block 810, the processor may identify a remaining input chunk. Remaining input chunks may be input chunks of input tokens that may have yet to be transmitted by on the initial distributed AI computing device. Remaining input chunks may exist stored in a memory, such as a queue. In some embodiments, the processor identifying the remaining input chunks in optional block 810 may include the processor, the input chunking module, or the TX/RX module.

The processor may serially transmit input chunks to the distributed AI computing device, repeatedly implementing block 808. The processor may continue to transmit remaining input chunks identified in optional block 810.

With reference to the method 820, blocks 802-806 may be implemented by the processor in a similar manner as described herein for the method 800. In some embodiments, the processor implementing blocks 802-806 may include a processing system (e.g., SIP 100, SoC 102, 104, processor 110, 112, 114, 116, 118, 121, 122, 121, 122, 152, 160, processing system 302, 322 in FIGS. 1, 3A, and 3B) or an input chunking module (e.g., input chunking module 310 in FIG. 3A).

In block 822, the processor may input an input chunk to the LXM on the initial distributed AI computing device. The processor may serially input sequential input chunks of the input chunk size to one or more input layers (e.g., embedding layer 404, positional encoding layer 406, input layer 430 in FIGS. 4-5F) of the LXM. In some embodiments, the processor inputting the input chunk to the LXM on the initial distributed AI computing device in block 822 may include the processor, the input chunking module, or a distributed LXM execution module (e.g., distributed LXM execution module 316 in FIG. 3A).

In block 824, the processor may process the input chunk using the LXM. Based on a configuration of the initial distributed AI computing device to implement the distributed LXM, implementing the distributed LXM may include implementing the one or more input layers and/or the one or more decoder layers (e.g., decoder layer 410, 412, 414, 416, 434, 434a, 434b, 434c, 434d in FIGS. 4-5F) of the portion allocated to the initial distributed AI computing device. For example, based on the indication of the portion of the distributed LXM allocated to the initial distributed AI computing device, the processor may be configured to implement the allocated portion, including the one or more input layers, such as during a prefill phase. Based on the indication of the portion of the distributed LXM allocated to the initial distributed AI computing device, the processor may implement the allocated portion, including one or more decoder layers. In some embodiments, the processor processing the input chunk using the LXM in block 824 may include the processor or the distributed LXM execution module.

In block 826, the processor may generate an intermediary chunk (e.g., C1-1, C2-1, C3-1, C4-1, C1-2, C2-2, C3-2, C4-2 in FIG. 6B). Processing the input chunk by execution of the one or more input layers and/or the one or more decoders layers of the portion of the LXM allocated to the initial distributed AI computing device may generate an intermediary chunk. In some embodiments, the processor generating the intermediary chunk in block 826 may include the processor or the distributed LXM execution module.

In block 828, the processor may transmit the intermediary chunk to a distributed AI computing device. In some embodiments, the processor may transmit the intermediary chunk directed to a specific distributed AI computing device configured to implement a next portion of the distributed LXM or broadcast the intermediary chunk to multiple distributed AI computing devices. Broadcasting the intermediary chunk may enable dynamic redistribution of the LXM across the distributed AI computing devices during execution of the LXM for an input. Broadcasting the intermediary chunk may provide any distributed AI computing device configured to implement a portion of the LXM after execution of the LXM for the input has commenced with the appropriate intermediary chunk for processing. In some embodiments, the processor transmitting the intermediary chunk to the distributed AI computing device in block 828 may include the processor or a TX/RX module (e.g., TX/RX module 314 in FIG. 3A).

In optional block 830, the processor may identify a remaining input chunk. Remaining input chunks may be input chunks of input tokens that may have yet to be processed on the initial distributed AI computing device. Remaining input chunks may exist stored in a memory, such as a queue. In some embodiments, the processor identifying the remaining input chunks in optional block 830 may include the processor the TX/RX module, or the distributed LXM execution module.

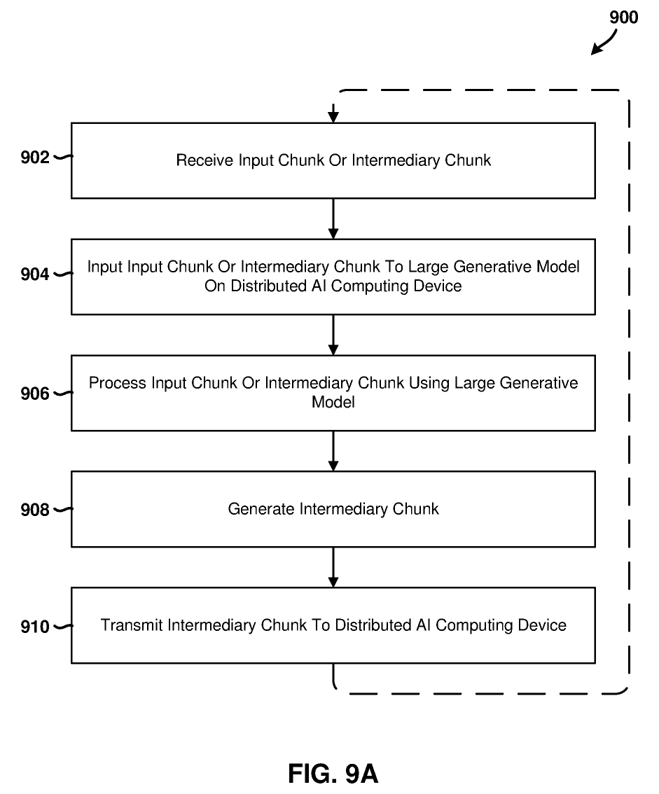

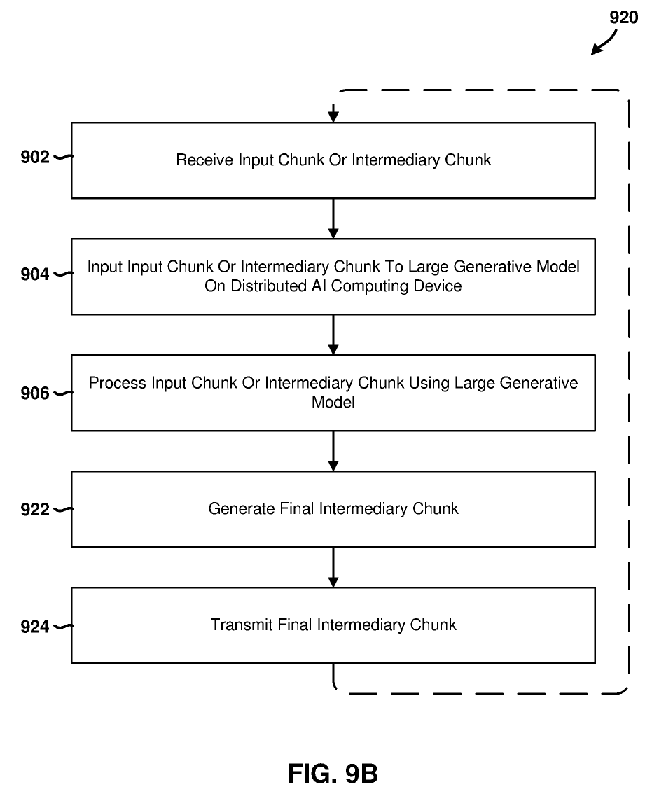

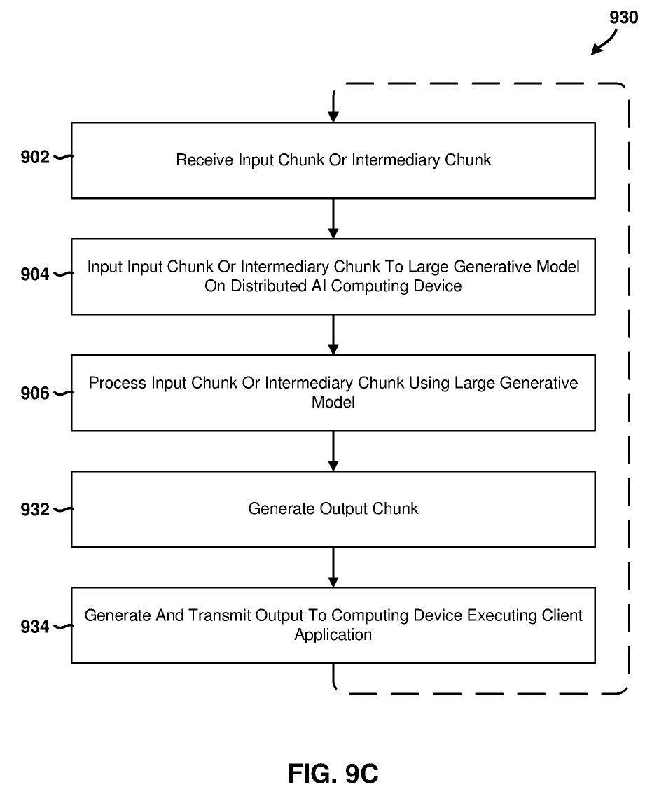

The processor may serially input the input chunks, repeatedly implementing block 822, and serially implement the layers of the LXM that the processor is configured to implement, repeatedly implementing blocks 824 and 826. The processor may also serially transmit generated intermediary chunks to the distributed AI computing device, repeatedly implementing block 828. For example, the processor may implement the one or more input layers and/or the one or more decoder layers for a first input chunk to generate a first intermediary chunk. In parallel with transmitting the first intermediary chunk to the distributed AI computing device, the processor may implement the one or more input layers and/or the one or more decoder layers for a second input chunk to generate a second intermediary chunk. The processor may also implement the one or more input layers and/or the one or more decoder layers for the second input chunk in parallel with one or more distributed AI computing device implementing the distributed LXM for the first intermediary chunk, as described further herein for the methods 900, 920, 930 with reference to FIGS. 9A-9C. The processor may continue to process subsequent input chunks in parallel with the transmission of previous intermediary chunks.

FIGS. 9A-9C are process flow diagrams illustrating methods 900, 920, 930 for implementing an LXM (e.g., LXM 400 in FIG. 4) distributed across a cluster of computing devices (e.g., computing device 202, 204, 204a, 204b, 504, 604a, 604b, 604c in FIGS. 2-3B and 5A-6B) of a distributed AI computing system (e.g., distributed AI computing system 200, 200a, 200b, 200c, 200d, 200e, 200f in FIGS. 2-3B, and 5A-5F) in accordance with some embodiments. With reference to FIGS. 1-9C, the methods 900, 920, 930 may be performed in a computing device by at least one processing system including at least one memory having executable instructions thereon coupled to one or more processors configured to execute the executable instructions (e.g., SIP 100, SoC 102, 104, processor 110, 112, 114, 116, 118, 121, 122, 121, 122, 152, 160, processing system 302, 322 in FIGS. 1, 3A, and 3B) and components (e.g., module 308-316 in FIGS. 3A and 3B) or subsystems discussed in this application. Means for performing the functions of the operations in the methods 900, 920, 930 may include a processing system including one or more processors, at least one memory, and other components described herein. Further, one or more processors of a processing system may be configured with software or firmware to perform some or all of the operations of the methods 900, 920, 930. In order to encompass the alternative configurations enabled in various embodiments, the hardware implementing any or all of the methods 900, 920, 930 is referred to herein as a “processor.”

With reference to the method 900, in block 902, the processor may receive an input chunk (C1, C2, C3, C4 in FIG. 6B) or an intermediary chunk (e.g., C1-1, C2-1, C3-1, C4-1, C1-2, C2-2, C3-2, C4-2 in FIG. 6B). Based on a configuration of the distributed AI computing device to implement the distributed LXM, implementing the distributed LXM may include implementing the one or more input layers (e.g., embedding layer 404, positional encoding layer 406, input layer 430 in FIGS. 4-5F) and/or the one or more decoder layers (e.g., decoder layer 410, 412, 414, 416, 434, 434a, 434b, 434c, 434d in FIGS. 4-5F) of the portion allocated to the distributed AI computing device. The processor of a distributed AI computing device configured for implementing the one or more input layers and/or one or more decoder layers may receive an input chunk transmitted from an initial distributed AI computing device. The processor of the distributed AI computing device configured for implementing the one or more decoder layers may receive an intermediary chunk transmitted from an initial distributed AI computing device or a different distributed AI computing device depending on the position in the LXM of the portion of the LXM allocated to the distributed AI computing device. In some embodiments, the processor receiving the input chunk or the intermediary chunk in block 902 may include a processing system (e.g., SIP 100, SoC 102, 104, processor 110, 112, 114, 116, 118, 121, 122, 121, 122, 152, 160, processing system 302, 322 in FIGS. 1, 3A, and 3B) or a TX/RX module (e.g., TX/RX module 314 in FIG. 3B).

In block 904, the processor may input the input chunk or intermediary chunk to LXM on the distributed AI computing device. The processor may serially input the input chunks into the one or more input layers of the portion of the LXM allocated to the distributed AI computing device. The processor may serially input intermediary chunks to the one or more decoder layers of the portion of the LXM allocated to the distributed AI computing device. In some embodiments, the processor inputting the input chunk or the intermediary chunk to the LXM on the distributed AI computing device in block 904 may include the processor or a distributed LXM execution module (e.g., distributed LXM execution module 316 in FIG. 3B).

In block 906, the processor may process the input chunk or the intermediary chunk using the LXM. Based on a configuration of the distributed AI computing device to implement the distributed LXM, implementing the distributed LXM may include implementing the one or more input layers of the LXM and/or the one or more decoder layers of the portion allocated to the distributed AI computing device. Based on the indication of the portion of the distributed LXM allocated to the distributed AI computing device, the processor may implement the allocated portion, including one or more decoder layers. In some embodiments, the processor processing the input chunk or the intermediary chunk using the LXM in block 906 may include the processor or the distributed LXM execution module.

In block 908, the processor may generate an intermediary chunk (e.g., C1-2, C2-2, C3-2, C4-2 in FIG. 6). Processing the input chunk or the intermediary chunk by execution of the one or more input layers of the LXM and/or the one or more decoders layers of the portion of the LXM allocated to the distributed AI computing device may generate a next intermediary chunk. In some embodiments, the processor generating the intermediary chunk in block 908 may include the processor or the distributed LXM execution module.

In block 910, the processor may transmit the intermediary chunk to a distributed AI computing device. In some embodiments, the processor may transmit the next intermediary chunk directed to a specific distributed AI computing device configured to implement a next portion of the distributed LXM or broadcast the next intermediary chunk to multiple distributed AI computing devices. Again, broadcasting the next intermediary chunk may enable dynamic redistribution of the LXM across the distributed AI computing devices during execution of the LXM for an input. Broadcasting the next intermediary chunk may provide any distributed AI computing device configured to implement a portion of the LXM after execution of the LXM for the input has commenced with the appropriate intermediary chunk for processing. In some embodiments, the processor transmitting the intermediary chunk to the distributed AI computing device in block 910 may include the processor or the TX/RX module.

The processor may serially receive and input the input chunks or the intermediary chunks, repeatedly implementing blocks 902 and 904, and serially implement the layers of the LXM that the processor is configured to implement, repeatedly implementing blocks 906 and 908. The processor may also serially transmit generated intermediary chunks to the distributed AI computing device, repeatedly implementing block 910. For example, the processor may implement the one or more decoder layers for a first intermediary chunk to generate a second intermediary chunk. In parallel with transmitting the second intermediary chunk to the distributed AI computing device, the processor may implement the one or more decoder layers for a third intermediary chunk to generate a fourth intermediary chunk. The processor may also implement the one or more decoder layers for the first intermediary chunk in parallel with the initial distributed AI computing device or the one or more distributed AI computing device implementing the distributed LXM for generating the third intermediary chunk, as described further herein for the methods 820, 900 with reference to FIGS. 8B and 9A. The processor may also implement the one or more decoder layers for the fourth intermediary chunk in parallel with one or more distributed AI computing device implementing the distributed LXM for the second intermediary chunk, as described further herein for the methods 920, 930 with reference to FIGS. 9B and 9C. The processor may continue to process subsequent intermediary chunks in parallel with the transmission of previous intermediary chunks.

With reference to the method 920, blocks 902-906 may be implemented by the processor in a similar manner as described herein for the method 900. In some embodiments, the processor implementing blocks 902-906 may include a processing system (e.g., SIP 100, SoC 102, 104, processor 110, 112, 114, 116, 118, 121, 122, 121, 122, 152, 160, processing system 302, 322 in FIGS. 1, 3A, and 3B), a TX/RX module (e.g., TX/RX module 314 in FIG. 3B), or a distributed LXM execution module (e.g., distributed LXM execution module 316 in FIG. 3B).

In block 922, the processor may generate a final intermediary chunk (e.g., C1-1, C2-1, C3-1, C4-1, C1-2, C2-2, C3-2, C4-2 in FIG. 6B). A final intermediary chunk may be like any other intermediary chunk but generated by a final portion of the LXM, having one or more decoder layers (e.g., decoder layer 410, 412, 414, 416, 434, 434a, 434b, 434c, 434d in FIGS. 4-5F), positioned in the LXM immediately preceding the one or more output layers (e.g., linear layers 422, softmax layer 424, output layers 434 in FIGS. 4-5F). Processing the intermediary chunk by execution of the one or more decoders layers of the portion of the LXM allocated to the distributed AI computing device may generate the final intermediary chunk. In some embodiments, the processor generating the final intermediary chunk in block 922 may include the processor or the distributed LXM execution module.

In block 924, the processor may transmit the final intermediary chunk. In some embodiments, the processor may transmit the final intermediary chunk directed to the initial distributed AI computing device or another distributed AI computing device configured to implement output layers of the distributed LXM or broadcast the final intermediary chunk to multiple computing devices. Again, broadcasting the final intermediary chunk may enable dynamic redistribution of the LXM across the distributed AI computing devices during execution of the LXM for an input. Broadcasting the final intermediary chunk may provide any distributed AI computing device configured to implement a portion of the LXM after execution of the LXM for the input has commenced with the appropriate intermediary chunk for processing. In some embodiments, the processor transmitting the final intermediary chunk in block 924 may include the processor or the TX/RX module.

The processor may serially receive and input the intermediary chunks, repeatedly implementing blocks 902 and 904, and serially implement the layers of the LXM that the processor is configured to implement, repeatedly implementing blocks 906 and 922. The processor may also serially transmit generated final intermediary chunks to the initial distributed AI computing device or another distributed AI computing device, repeatedly implementing block 924. For example, the processor may implement the one or more decoder layers for a first intermediary chunk to generate a first final intermediary chunk. In parallel with transmitting the first final intermediary chunk to the initial distributed AI computing device or another distributed AI computing device, the processor may implement the one or more decoder layers for a second intermediary chunk to generate a second final intermediary chunk. The processor may also implement the one or more decoder layers for the first intermediary chunk in parallel with the initial distributed AI computing device or one or more distributed AI computing devices implementing the distributed LXM for generating the second intermediary chunk, as described further herein for the methods 820, 900 with reference to FIGS. 8B and 9A. The processor may continue to process subsequent intermediary chunks in parallel with the transmission of previous intermediary chunks.

With reference to the method 930, blocks 902-906 may be implemented by the processor in a similar manner as described herein for the method 900. In some embodiments, the processor implementing blocks 902-906 may include a processing system (e.g., SIP 100, SoC 102, 104, processor 110, 112, 114, 116, 118, 121, 122, 121, 122, 152, 160, processing system 302, 322 in FIGS. 1, 3A, and 3B), a TX/RX module (e.g., TX/RX module 314 in FIG. 3B), or a distributed LXM execution module (e.g., distributed LXM execution module 316 in FIG. 3B).

In block 932, the processor may generate an output chunk (e.g., output potential 426 in FIGS. 4-5F). An output chunk may be generated from a final intermediary chunk generated by the distributed AI computing device executing the allocated portion of the LXM, having one or more decoder layers (e.g., decoder layer 410, 412, 414, 416, 434, 434a, 434b, 434c, 434d in FIGS. 4-5F), positioned in the LXM immediately preceding the one or more output layers (e.g., linear layers 422, softmax layer 424, output layers 434 in FIGS. 4-5F). Processing the final intermediary chunk by execution of the one or more output layers of the portion of the LXM allocated to the distributed AI computing device may generate the output chunk. In some embodiments, the processor generating the output chunk in block 932 may include the processor or the distributed LXM execution module.

In block 934, the processor may transmit an output. In some embodiments, the processor may transmit the output directed to a computing device executing a client application (e.g., client 502 in FIGS, 5A-5F) that initiated execution of the LXM or broadcast the output token to multiple computing devices. In some embodiments, the output transmitted to the computing device executing the client application may be an output chunk. In some embodiments, the processor may assemble the output chunks derived from an input (e.g., input 402, 602 in FIGS. 4, 6A, and 6B) into an output tensor. The output transmitted to the computing device executing the client application may be the output tensor. In some embodiments, the computing device executing the client application may be the initial distributed AI computing device or another computing device. In some embodiments, the processor transmitting the output in block 934 may include the processor or the TX/RX module.

The processor may serially receive and input the final intermediary chunks, repeatedly implementing blocks 902 and 904, and serially implement the layers of the LXM that the processor is configured to implement, repeatedly implementing blocks 906 and 932. The processor may also serially transmit generated output chunks to the computing device executing the client application, repeatedly implementing block 934. For example, the processor may implement the one or more decoder layers and one or more output layers for a first final intermediary chunk to generate a first output chunk. In parallel with transmitting the first output chunk to the computing device executing the client application, the processor may implement the one or more decoder layers and one or more output layers for a second final intermediary chunk to generate a second output chunk. The processor may also implement the one or more decoder layers and one or more output layers for the first final intermediary chunk in parallel with the initial distributed AI computing device or one or more distributed AI computing device implementing the distributed LXM for generating the second final intermediary chunk, as described further herein for the methods 820, 900, 920 with reference to FIGS. 8B, 9A, and 9B. The processor may continue to process subsequent intermediary chunks in parallel with the transmission of previous intermediary chunks.

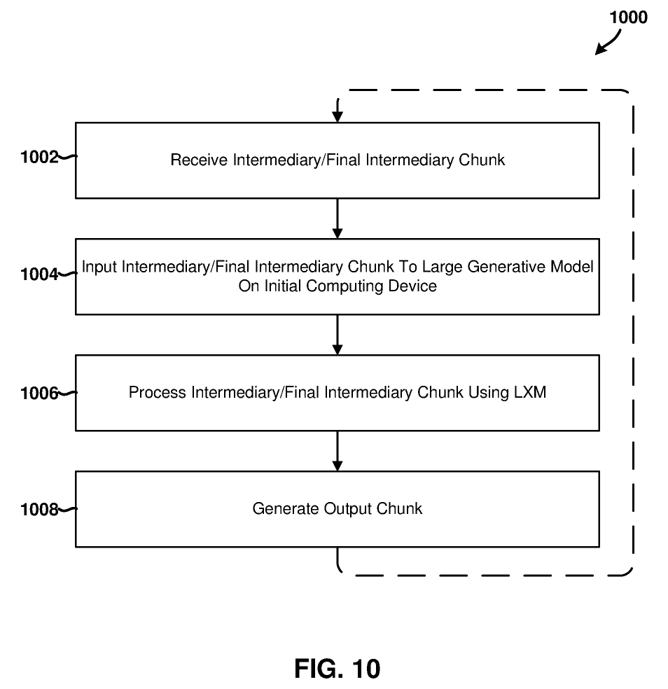

FIG. 10 is a process flow diagram illustrating a method 1000 for implementing an LXM (e.g., LXM 400 in FIG. 4) distributed across a cluster of computing devices (e.g., computing device 202, 204, 204a, 204b, 504, 604a, 604b, 604c in FIGS. 2-3B and 5A-6B) of a distributed AI computing system (e.g., distributed AI computing system 200, 200a, 200b, 200c, 200d, 200e, 200f in FIGS. 2-3B and 5A-5F) in accordance with some embodiments. With reference to FIGS. 1-10, the method 1000 may be performed in a computing device by at least one processing system including at least one memory having executable instructions thereon coupled to one or more processors configured to execute the executable instructions (e.g., SIP 100, SoC 102, 104, processor 110, 112, 114, 116, 118, 121, 122, 121, 122, 152, 160, processing system 302, 322 in FIGS. 1, 3A, and 3B) and components (e.g., module 308-316 in FIGS. 3A and 3B) or subsystems discussed in this application. Means for performing the functions of the operations in the method 1000 may include a processing system including one or more processors, at least one memory, and other components described herein. Further, one or more processors of a processing system may be configured with software or firmware to perform some or all of the operations of the method 1000. In order to encompass the alternative configurations enabled in various embodiments, the hardware implementing any or all of the method 1000 is referred to herein as a “processor.”

In block 1002, the processor may receive an intermediary chunk (e.g., C1-1, C2-1, C3-1, C4-1, C1-2, C2-2, C3-2, C4-2 in FIG. 6). The processor of an initial distributed AI computing device may receive an intermediary chunk transmitted from a distributed AI computing device depending on the position in the LXM of the portion of the LXM allocated to the distributed AI computing device. For example, the intermediary chunk may be a final intermediary chunk. The final intermediary chunk may be received from a distributed AI computing device configured with a portion of the LXM, having one or more decoder layers (e.g., decoder layer 410, 412, 414, 416, 434, 434a, 434b, 434c, 434d in FIGS. 4-5F), positioned in the LXM immediately preceding the one or more output layers (e.g., linear layers 422, softmax layer 424, output layers 434 in FIGS. 4-5F). Based on a configuration of the initial distributed AI computing device to implement the distributed LXM, implementing the distributed LXM may include implementing the one or more decoder layers and/or the one or more output layers of the portion allocated to the initial distributed AI computing device. The processor of the initial distributed AI computing device configured for implementing the one or more decoder layers may receive an intermediary chunk transmitted from an initial distributed AI computing device or a different distributed AI computing device depending on the position in the LXM of the portion of the LXM allocated to the initial distributed AI computing device. The processor of the initial distributed AI computing device configured for implementing the one or more output layers may receive a final intermediary chunk transmitted from a different distributed AI computing device. In some embodiments, the processor receiving the intermediary chunk in block 1002 may include a processing system (e.g., SIP 100, SoC 102, 104, processor 110, 112, 114, 116, 118, 121, 122, 121, 122, 152, 160, processing system 302, 322 in FIGS. 1, 3A, and 3B) or a TX/RX module (e.g., TX/RX module 314 in FIG. 3A).

In block 1004, the processor may input the intermediary chunk to the LXM on the initial distributed AI computing device. The processor may serially input the intermediary chunks to one or more decoder layers of the LXM. In some embodiments, the processor may serially input the final intermediary chunk to one or more output layers of the LXM on the initial distributed AI computing device. In some embodiments, the processor inputting the intermediary chunk to the LXM on the initial distributed AI computing device in block 1004 may include the processor or a distributed LXM execution module (e.g., distributed LXM execution module 316 in FIG. 3A).

In block 1006, the processor may process the intermediary chunk using the LXM on the initial distributed AI computing device. Based on an indication of an allocated portion of the LXM, a configuration of the initial distributed AI computing device may be to implement the distributed LXM. In some embodiments, implementing the distributed LXM may include implementing the one or more decoder layers on the initial distributed AI computing device for the intermediary chunk and generating the final intermediary chunk. In some embodiments, implementing the distributed LXM may include implementing the one or more output layers on the initial distributed AI computing device for the final intermediary chunk. In some embodiments, the processor processing the intermediary chunk using LXM on the initial distributed AI computing device in block 1006 may include the processor or the distributed LXM execution module.

In block 1008, the processor may generate an output chunk (e.g., output potential 426 in FIGS. 4-5F). Processing the final intermediary chunk by execution of the one or more output layers may generate the output chunk. In some embodiments, the processor may assemble the output chunks derived from an input (e.g., input 402, 602 in FIGS. 4, 6A, and 6B) into an output tensor. In some embodiments, the processor generating the output chunk in block 1008 may include the processor or the distributed LXM execution module.

The processor may serially receive and input the intermediary chunks, repeatedly implementing blocks 1002 and 1004, and serially implement the layers of the LXM that the processor is configured to implement, repeatedly implementing blocks 1006 and 1008. For example, the processor may implement the one or more output layers for a first intermediary chunk to generate a first output chunk. The processor may also implement the one or more output layers for the first intermediary chunk in parallel with the initial distributed AI computing device or one or more distributed AI computing device implementing the distributed LXM for generating a second intermediary chunk, as described further herein for the methods 820, 900, 920 with reference to FIGS. 8B-9B.

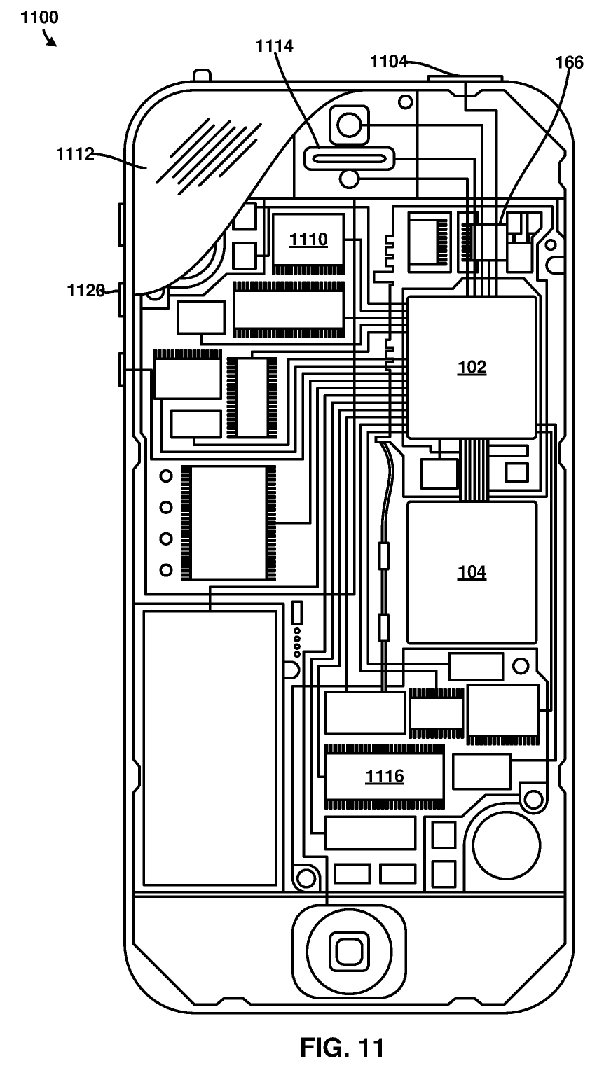

FIG. 11 is a component block diagram of a computing device 1100 suitable for use with various embodiments. With reference to FIGS. 1-11, various embodiments may be implemented on a variety of computing devices 1100, an example of which is illustrated in FIG. 11 in the form of a smartphone. The computing device 1100 may include a first SOC 102 coupled to a second SOC 104. The first and second SoCs 102, 104 may be coupled to internal memory 1116, a touch-sensitive display 1112, a speaker 1114, and a user-facing camera 168. As described, in some embodiments the first and second SoCs 102, 104 may include or be configured with an attention-tracker module (e.g., 204) that is configured to process data from the user-facing camera 168 and/or the touch-sensitive display 1112 to track the user’s attention to subject matter presented on the touch-sensitive display 1112. The first and second SOCs 102, 104 may also be coupled to at least one subscriber identity module (SIM) 1140 and/or a SIM interface that may store information supporting a first 5GNR subscription and a second 5GNR subscription, which support service on a 5G non-standalone (NSA) network.

The computing device 1100 may include an antenna 1104 for sending and receiving electromagnetic radiation that may be connected to a wireless transceiver 166 coupled to one or more processors in the first and/or second SOCs 102, 104. The computing device 1100 may also include menu selection buttons or rocker switches 1120 for receiving user inputs.

The computing device 1100 also includes a sound encoding/decoding (CODEC) circuit 1110, which digitizes sound received from a microphone into data packets suitable for wireless transmission and decodes received sound data packets to generate analog signals that are provided to the speaker to generate sound. Also, one or more of the processors in the first and second circuitries 102, 104, wireless transceiver 166 and CODEC 1110 may include a digital signal processor (DSP) circuit (not shown separately).

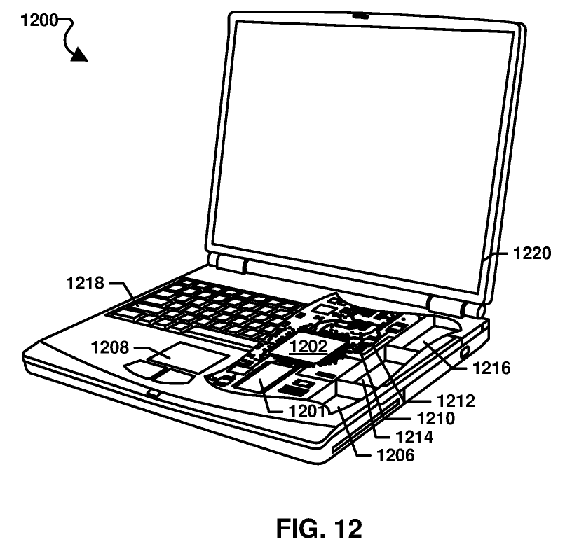

Various embodiments (including, but not limited to, embodiments described above with reference to FIGS. 1-10) may be implemented in a wide variety of wireless devices and computing systems including a laptop computer 1200, an example of which is illustrated in FIG. 12. With reference to FIGS. 1-12, a laptop computer may include a processor 1202 coupled to volatile memory 1201 and a large capacity nonvolatile memory, such as a disk drive 1206 or Flash memory. The laptop computer 1200 may include a touchpad touch surface 1208 that serves as the computer’s pointing device. The touchpad touch surface 1208 may be configured to provide data to the processor 1202 regarding drag, scroll, and flick gesture user inputs. The laptop computer 1200 may also include a user-facing camera 168 coupled to the processor 1202.

Additionally, the laptop computer 1200 may have one or more antenna 1210 for sending and receiving electromagnetic radiation that may be connected to a wireless data link and/or cellular telephone transceiver 1212 coupled to the processor 1202. The computer 1200 may also include a BT transceiver 1214, a compact disc (CD) drive 1216, a keyboard 1218, and a display 1220 all coupled to the processor 1202. Other configurations of the computing device may include a computer mouse or trackball coupled to the processor (e.g., via a universal serial bus (USB) input) as are well known, which may also be used in conjunction with various embodiments.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processing system including at least one memory having executable instructions thereon coupled to one or more processors configured to execute the executable instructions in order to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method performed by at least one processor of at least one computing device for distributing a large generative AI model (LXM) across a cluster of computing devices, may include: dividing the LXM into first portions that each has at least one layer of the LXM in which dividing the LXM into first portions is based on a first set of characteristics of the computing devices of the cluster; and allocating the first portions to a first plurality of the computing devices for execution.

Example 2. The method of example 1, further including: receiving a second set of characteristics of the computing devices including at least one value different from values in the first set of characteristics; dividing the LXM into second portions that each has at least one layer of the LXM in which dividing the LXM into second portions is based on the second set of characteristics; and allocating the second portions to a second plurality of the computing devices.

Example 3. The method of example 2, in which the second plurality of the computing devices includes at least one computing device of the first plurality of the computing devices.

Example 4. The method of either of any of examples 1-3, in which the first set of characteristics of the computing devices includes: available memory bandwidth; available compute capacity; and available communication bandwidth between the computing devices.

Example 5. The method of any of examples 1-4, in which dividing the LXM into the first portions based on the first set of characteristics of the computing devices of the cluster may include dividing the LXM into the first portions based on the first set of characteristics of the computing devices of the cluster so as to approximately balance execution time of the first portions by the first plurality of the computing devices.

Example 6. The method of any of examples 1-5, in which dividing the LXM into the first portions based on the first set of characteristics of the computing devices of the cluster may include dividing the LXM into the first portions based on the first set of characteristics of the computing devices of the cluster and a length of at least one input token.

Example 7. The method of any of examples 1-6, in which the at least one layer of the LXM of any of the first portions includes one or more of one or more input layers, one or more decoder layers, or one or more output layers.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different types of memories and memory technologies are available or contemplated in the future, any or all of which may be included and used in systems and computing devices that implement the various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement the various embodiments may also include or use electronic (solid-state) non-volatile computer storage mediums, such as FLASH memory. Each of the above-mentioned memory technologies include, for example, elements suitable for storing instructions, programs, control signals, and/or data for use in a computing device, system on chip (SOC) or other electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by processor of at least one computing device for distributing a large generative AI model (LXM) across a cluster of computing devices, comprising:
dividing the LXM into first portions that each has at least one layer of the LXM, wherein dividing the LXM is based on a first set of characteristics of the computing devices of the cluster; and
allocating the first portions to a first plurality of the computing devices for execution.

2. The method of claim 1, further comprising:
receiving a second set of characteristics of the computing devices including at least one value different from values in the first set of characteristics;
dividing the LXM into second portions that each has at least one layer of the LXM, wherein dividing the LXM is based on the second set of characteristics; and
allocating the second portions to a second plurality of the computing devices.

3. The method of claim 2, wherein the second plurality of the computing devices includes at least one computing device of the first plurality of the computing devices.

4. The method of claim 1, wherein the first set of characteristics of the computing devices includes:
available memory bandwidth;
available compute capacity; and
available communication bandwidth between the computing devices.

5. The method of claim 1, wherein dividing the LXM into the first portions based on the first set of characteristics of the computing devices of the cluster comprises dividing the LXM into the first portions of LXM based on the first set of characteristics of the first plurality of computing devices of the cluster so as to approximately balance execution time of the first portions by the first plurality of the computing devices.

6. The method of claim 1, wherein dividing the LXM into the first portions based on the first set of characteristics of the computing devices of the cluster comprises dividing the LXM into the first portions based on the first set of characteristics of the computing devices of the cluster and a length of at least one input token.

7. The method of claim 1, wherein the at least one layer of the LXM of any of the first portions includes one or more of one or more input layers, one or more decoder layers, or one or more output layers.

8. A computing device, comprising:
at least one memory having executable instructions thereon; and
one or more processors configured to execute the executable instructions in order to cause the one or more processors to:
divide a large generative AI model (LXM) into first portions that each has at least one layer of the LXM, wherein dividing the LXM is based on a first set of characteristics of computing devices of a cluster of computing devices; and
allocate the first portions to a first plurality of the computing devices for execution.

9. The computing device of claim 8, wherein the one or more processors are configured to execute the executable instructions in order to further cause the one or more processors to:
receive a second set of characteristics of the computing devices including at least one value different from values in the first set of characteristics;
divide the LXM into second portions that each has at least one layer of the LXM, wherein dividing the LXM is based on the second set of characteristics; and
allocate the second portions to a second plurality of the computing devices.

10. The computing device of claim 9, wherein the second plurality of the computing devices includes at least one computing device of the first plurality of the computing devices.

11. The computing device of claim 8, wherein the first set of characteristics of the computing devices includes:
available memory bandwidth;
available compute capacity; and
available communication bandwidth between the computing devices.

12. The computing device of claim 8, wherein the one or more processors are configured to execute the executable instructions in order to further cause the one or more processors to divide the LXM into the first portions, wherein dividing the LXM is based on the first set of characteristics of the computing devices of the cluster so as to approximately balance execution time of the first portions by the first plurality of the computing devices.

13. The computing device of claim 8, wherein the one or more processors are configured to execute the executable instructions in order to further cause the one or more processors to divide the LXM into the first portions based on the first set of characteristics of the computing devices of the cluster and a length of at least one input token.

14. The computing device of claim 8, wherein the at least one layer of the LXM of any of the first portions includes one or more of one or more input layers, one or more decoder layers, or one or more output layers.

15. A non-transitory processor-readable medium having stored thereon processor-executable instructions configured to cause a processor of a computing device to perform operations for distributing a large generative AI model (LXM) across a cluster of computing devices, comprising:
dividing the LXM into first portions that each has at least one layer of the LXM, wherein dividing the LXM is based on a first set of characteristics of the computing devices of the cluster; and
allocating the first portions to a first plurality of the computing devices for execution.

16. The non-transitory processor-readable medium of claim 15, wherein the stored processor-executable instructions are configured to cause a processor of a computing device to perform operations further comprising:
receiving a second set of characteristics of the computing devices including at least one value different from values in the first set of characteristics;
dividing the LXM into second portions that each has at least one layer of the LXM, wherein dividing the LXM is based on the second set of characteristics; and
allocating the second portions to a second plurality of the computing devices.

17. The non-transitory processor-readable medium of claim 15, wherein the stored processor-executable instructions are configured to cause a processor of a computing device to perform operations wherein the first set of characteristics of the computing devices includes:
available memory bandwidth;
available compute capacity; and
available communication bandwidth between the computing devices.

18. The non-transitory processor-readable medium of claim 15, wherein the stored processor-executable instructions are configured to cause a processor of a computing device to perform operations wherein dividing the LXM into the first portions based on the first set of characteristics of the computing devices of the cluster comprises dividing the LXM into the first portions LXM based on the first set of characteristics of the first plurality of computing devices of the cluster so as to approximately balance execution time of the first portions by the first plurality of the computing devices.

19. The non-transitory processor-readable medium of claim 15, wherein the stored processor-executable instructions are configured to cause a processor of a computing device to perform operations wherein dividing the LXM into the first portions based on the first set of characteristics of the computing devices of the cluster comprises dividing the LXM into the first portions based on the first set of characteristics of the computing devices of the cluster and a length of at least one input token.

20. The non-transitory processor-readable medium of claim 15, wherein the stored processor-executable instructions are configured to cause a processor of a computing device to perform operations wherein the at least one layer of the LXM of any of the first portions includes one or more of one or more input layers, one or more decoder layers, or one or more output layers.
